(19) United States
(12) Patent Application Publication
(10) Pub. No.: US 2009/0193083 A1
(43) Pub. Date: Jul. 30, 2009

(54) METHOD AND APPARATUS TO LINK MEMBERS OF A GROUP

(76) Inventors: Gerald Rea, Scottsburg, IN (US); Robert A. Drake, Nashville, IN (US); Wesley G. Brandenburg, Underwood, IN (US)

Correspondence Address: BAKER & DANIELS LLP, 300 NORTH MERIDIAN STREET, SUITE 2700, INDIANAPOLIS, IN, 46204, US

(21) Appl. No.: 12/362,926

(22) Filed: Jan. 30, 2009

Related U.S. Application Data
(60) Provisional application No. 61/024,882, filed on Jan. 30, 2008.
(60) Provisional application No. 61/050,950, filed on May 6, 2008.

(51) Int. Cl. G06F 15/16

(52) U.S. Cl. 709/205

(57) ABSTRACT

A system for providing an online community to link members of a community together. The online community may include a business portal, a community portal, a people portal, and an education portal.

### CROSS REFERENCE TO RELATED APPLICATIONS

This application claims the benefit of U.S. Provisional Patent Application Ser. No. 61/024,882, filed Jan. 30, 2008, titled METHOD AND APPARATUS TO LINK MEMBERS OF A GROUP, Docket JORCH-P0001 and U.S. Provisional Patent Application Ser. No. 61/050,950, filed May 6, 2008, titled METHOD AND APPARATUS TO LINK MEMBERS OF A GROUP, Docket JORCH-P0001-05, the disclosures of which are expressly incorporated by reference herein.

### BACKGROUND AND SUMMARY

The present invention relates to systems and methods for improving interactions between members of an online community, and in particular, to improve the level of connectivity within the online community.

Current online communities, be it career sites like monster.com, social networking sites like Facebook, and other sites are dominated by only a small and typically geographically unconnected segment of the population. A need exists for an online community that takes in a larger cross-section of real world communities and which serves to strengthen the bonds of the real world community, bolster commerce, enrich education, and increase productivity.

In an exemplary embodiment of the present disclosure, a system for providing an online community is provided.

In another exemplary embodiment of the present disclosure, a system for providing an online community having a plurality of spaced apart online community member computing devices which are connectable to a network is provided. The system comprising a computing device being operatively connected to the plurality of online community member computing devices through the network; a memory accessible by the computing device; a database stored on the memory, the database including for each online community member information related to the online community member; a business portal having a plurality of business community applications; a community portal having a plurality of community applications; a people portal having a plurality of people community applications; and an education portal having a plurality of education community applications, wherein each of the business portal, the community portal, the people portal, and the education portal accessible by an online community member over the network. In a variation thereof, the business community applications include at least one of a statistics application, a business administration application, a web presence application, a job posting application, a labor pool application, a succession application, an expansion application, an open calls application, a jobs and applicants application, a personnel scheduling application, an employee attributes application, and an entrepreneurship application. In another variation thereof, the community applications include at least one of a workforce application, a religious based directory application, a search function application, a web page application, an events calendar application, a community forum application, a directory of key features in the community application, a what is open application, a community sites application, and a scheduling application. In yet another variation thereof, the people community applications include at least one of a messaging application, an events calendar application, and a web page application. In still another variation thereof, the education community applications include at least one of a cover letter creator application, a resume creator application, a goals application, a self-improvement application, a search job posting application, a search business application, and a student survey application.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a representative view of an online community;

FIG. 2 is a representative view of a computer system associated with a member of the online community;

FIG. 3 is a representative view of the interaction of a plurality of computer systems of FIG. 2 having access to various community applications and one or more databases over a network;

FIG. 4 is a representative view of various community applications for a first online community;

FIG. 5 is a representative view of various community applications associated with a business portal of the first online community of FIG. 4;

FIG. 6 is a representative view of various community applications associated with a people portal of the first online community of FIG. 4;

FIG. 7 is a representative view of various community applications associated with an education portal of the first online community of FIG. 4;

FIG. 8 is a representative view of various community applications associated with a community portal of the first online community of FIG. 4;

FIG. 9 illustrates a main portal screen for a business portal of the first online community of FIG. 4;

FIG. 10 is a representative view of a plurality of online communities;

FIGS. 11-35 illustrate various exemplary screens for the business portal of the first online community of FIG. 4;

FIG. 36 illustrates a main portal screen for a community portal of the first online community of FIG. 4;

FIG. 37 illustrates a main portal screen for an education portal of the first online community of FIG. 4;

FIGS. 38-56 illustrate various exemplary screens for the education portal of the first online community of FIG. 4;

FIG. 57 illustrates a main portal screen for a people portal of the first online community of FIG. 4;

FIG. 58 illustrates a web presence formatting screen for an account center of the first online community of FIG. 4;

FIGS. 59 and 60 illustrate exemplary screens of a message center of the first online community of FIG. 4; and

FIG. 61 illustrates an exemplary structure for the interaction between a server of the first online community of FIG. 4 and a member computing device.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

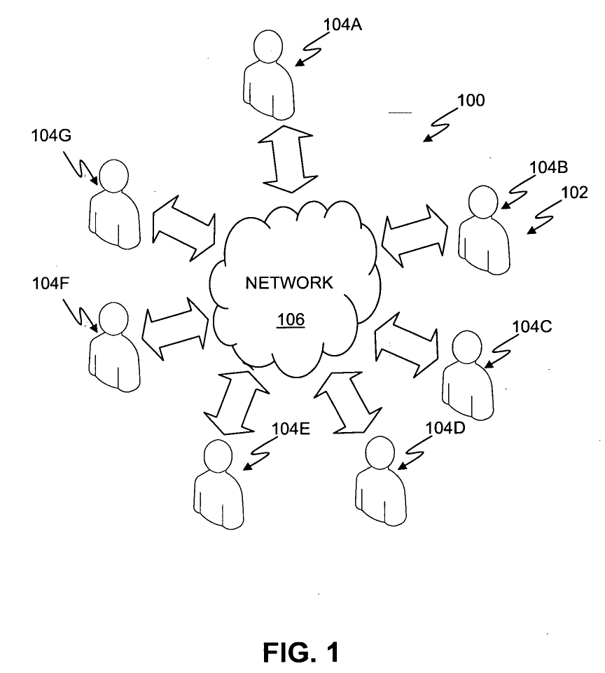

Referring to FIG. 1, an online community 100 is represented. Online community 100 is a collection of community members 102 (exemplary community members 104A-104G illustrated) which communicate through an electronic communication network 106. Electronic communication network 106 may be a collection of one or more wired or wireless networks through which a given community member 104A is able to communicate with another community member 104C.

In one embodiment, online community 100 is a closed community meaning that in order to post content or otherwise communicate with one or more of community member 102, a user must be a registered member of the online community 100. In one example, non-members of online community 100 may observe at least a portion of the content posted by online community members 102 and/or receive communications from an online community member 104. In one example, a new user must be invited to join the online community 100. In another example, a new user may freely join online community 100 by completing an account creation process, thereby becoming a registered user. Exemplary account creation processes are described in US Patent Application Serial No. ______, filed ______, titled METHOD AND APPARATUS FOR ACCOUNT MANAGEMENT, docket JORCH-P0001-02, the disclosure of which is expressly incorporated by reference herein.

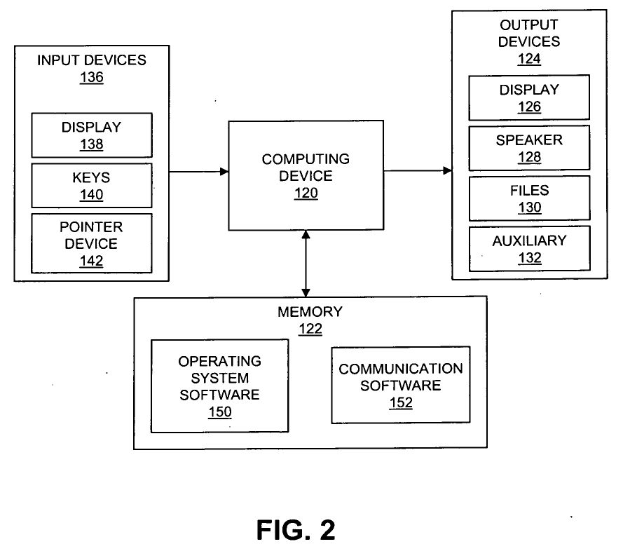

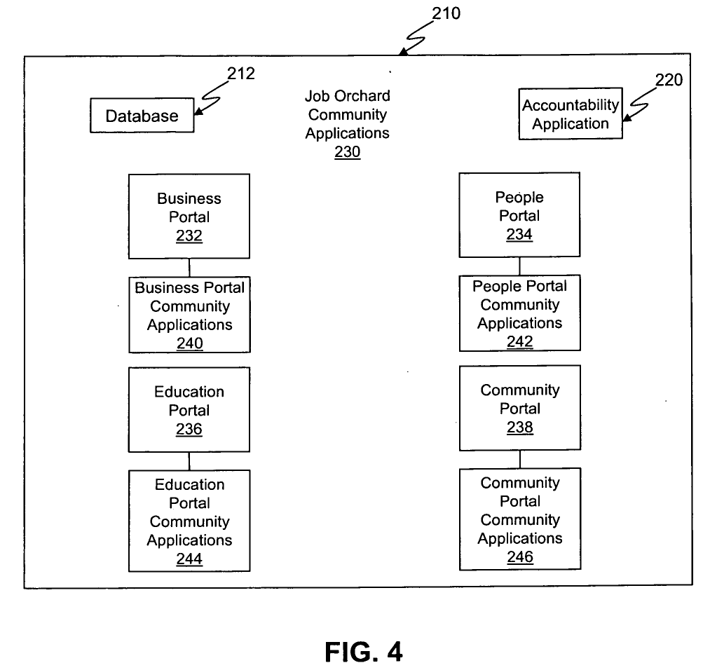

As stated above, members 102 communicate through an electronic communication network 106. Each member 102 has a member account 110 (see FIG. 4) related to online community 100. Each member 102 communicates and/or interacts as part of online community 100 through a computing device 120 (see FIG. 2). Computing device 120 may be a general purpose computer or a portable computing device. Although computing device 120 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, or other devices capable of the communications discussed herein.

Computing device 120 has access to a memory 122. Memory 122 is a computer readable medium and may be a single storage device or multiple storage devices, located either locally with computing device 120 or accessible across a network. Computer-readable media may be any available media that can be accessed by the computing device 120 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 120.

Computing device 120 has access to one or more output devices 124. Exemplary output devices 124 include a display 126, a speaker 128, a file 130, and an auxiliary device 132. Exemplary auxiliary devices 132 include devices which may be coupled to computing device 120, such as a printer. Files 103 may have various formats. In one embodiment, files 130 are portable document format (PDF) files. In one embodiment, files 130 are formatted for display by an Internet browser, such as Internet Explorer brand browser available from Microsoft Corporation of Redmond, Wash. or the Firefox brand browser available from Mozilla Corporation of Mountain View, Calif., and may include one or more of HyperText Markup Language (“HTML”), or other formatting instructions. In one embodiment, files 130 are files stored in memory 122 for transmission to another computing device and eventual presentation by another output device or to at least to influence information provided by the another output device.

Computing device 120 further has access to one or more input devices 136. Exemplary input devices 136 include a display 138 (such as a touch display), keys 140 (such as a keypad or keyboard), a pointer device (such as a mouse, a roller ball, a stylus), and other suitable devices by which an operator may provide input to computing device 120.

Memory 122 includes an operating system software 150. An exemplary operating system software is a WINDOWS operating system available from Microsoft Corporation of Redmond, Wash. An exemplary operating system for mobile devices is the iPhone operating system available from Apple Corporation of Cupertino, Calif. Memory 122 further includes communications software 152. Exemplary communications software 152 includes e-mail software, internet browser software, and other types of software which permit computing device 120 to communicate with other computing devices across a network 106. Exemplary networks include a local area network, a cellular network, a public switched network, and other suitable networks. An exemplary public switched network is the Internet.

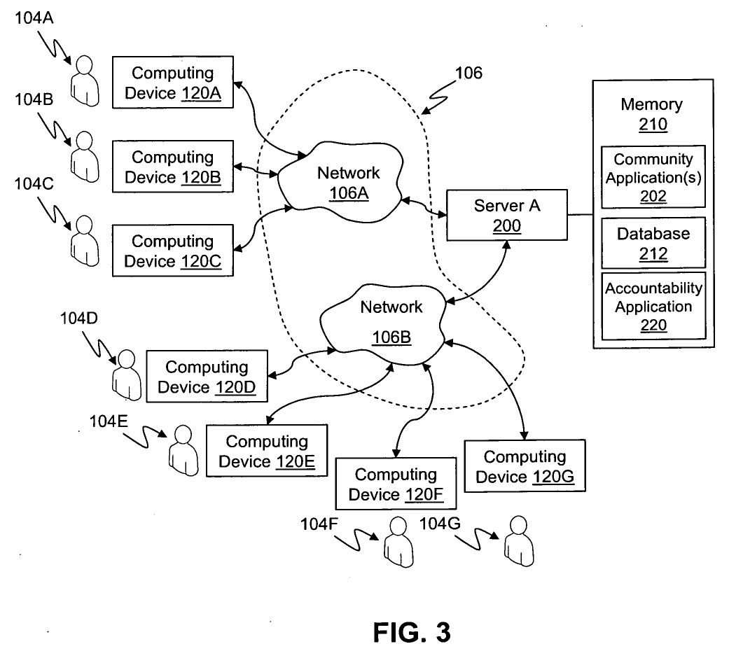

Referring to FIG. 3, each of members 104A-G of online community 100 are shown with an associated computing device 120. Of course, a given member 104 may have multiple computing devices 120 through which the member may access a computing device 200 which provides and/or manages one or more community applications 202. As illustrated, network 106 is shown including a first network 106A and a second network 106B. For example, computing devices 120A-120C may be handheld devices which communicate with computing device 200 through a cellular network 106A while computing devices 120D-120G are computers which communicate with computing device 200 through a public switched network, such as the Internet. In one example, computing devices 120A-120C also communicate with computing device 200 through the Internet, in that the provider of cellular service provides a connection to the Internet.

Computing device 200 is labelled as Server because it serves or otherwise makes available to computing devices 120A-120G various community applications 202. In one embodiment, computing device 200 is a web server and the various community applications include web sites which are served by computing device 200. Although a single server is shown, it is understood that multiple computing devices may be implemented to function as computing device 200.

Computing device 200 has access to a memory 210. Memory 210 is a computer readable medium and may be a single storage device or multiple storage devices, located either locally with computing device 200 or accessible across a network. Computer-readable media may be any available media that can be accessed by the computing device 200 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 200.

In addition to one or more community applications 202, memory 210 stores one or more databases 212 which are used by the community applications 202. In one embodiment, databases 212 are stored in a MySQL database system available from MySQL AB, a subsidiary of Sun Microsystems Inc, located in Cupertino, Calif.

In one embodiment, memory 210 also includes an accountability application 220. Additional details regarding accountability application 220 are provided in U.S. patent application Ser. No. 12/362,596, filed Jan. 30, 2009, titled METHOD AND APPARATUS FOR MANAGING COMMUNICATION SERVICES, docket JORCH-P0001-03, the disclosure of which is expressly incorporated by reference herein.

The types of community applications 202 depend on the type of online community. Exemplary types of online community 100 include auction sites, merchant sites, social networking sites, blogs, technical groups, professional groups, reference sites, event hosting sites, online education (e-learning) sites, online collaboration or meeting sites, news sites, and other sites wherein members are able to post content and/or exchange content. For example, at an auction site, community applications 202 include an application to list an item for auction, a posting application to provide feedback, and a message application to provide electronic messages between members. In a further example, at a social networking site, community applications may include a message application to provide electronic messages between members of the community. For news and group interest sites, community applications may include a posting application whereby a member may comment on an article presented through the news site. In yet another example, at a reference site (such as wikipedia), community applications include a content posting application to add information to the reference article and a comment posting application whereby a member may leave peer review comments about an article. In still a further example, at a career site (such as monster.com), community applications may include a job posting application and a resume submission application.

In one embodiment, online community 100 includes the community applications 230 shown in FIG. 4. Community applications 230 are divided into four portals: business portal 232; people portal 234, education portal 236; and community portal 238. Portals 232, 234, 236, and 238 are provided by computing device 200 and are accessible by an end user over one or more networks 106 by local computing devices 120. In one embodiment, portals 232, 234, 236, and 238 are presented on display 126 of computing device 120 as a user interface. Several exemplary screens of the user interface are provided herein. The various community applications 230 interact with a member 104 through the user interfaces and provide output information with display 126 and receive selection inputs from member 104 through input devices 136.

### Business Portal

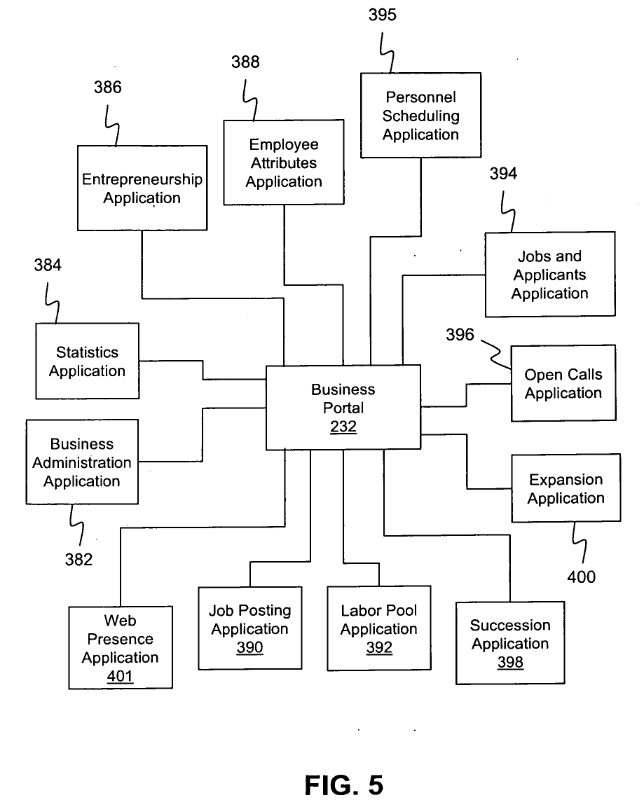

Business portal 232 provides information, advertisements, and/or web pages for the businesses in a real world community which are stored in databases 212. Exemplary real world communities include neighborhoods, towns, cities, townships, counties, regions, and other geographical boundaries. Another example of a business community is a cluster of businesses which consider themselves affiliated through complimentary services, operational similarities, or similar goals in the real world. Business portal provides access to multiple community business applications 240 which are described in more detail herein. An exemplary listing of community business applications are provided in FIG. 5.

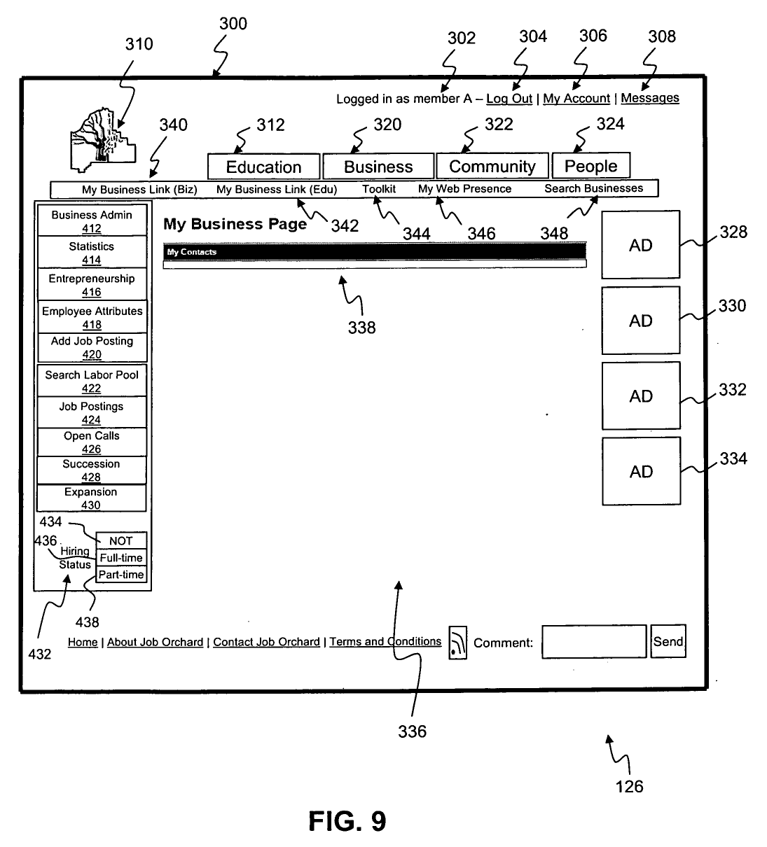

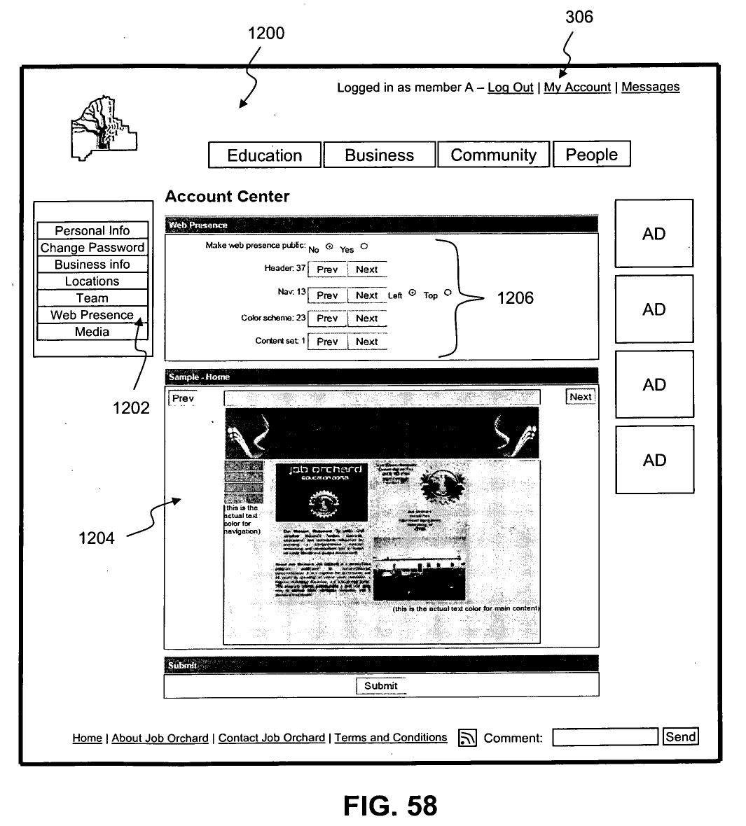

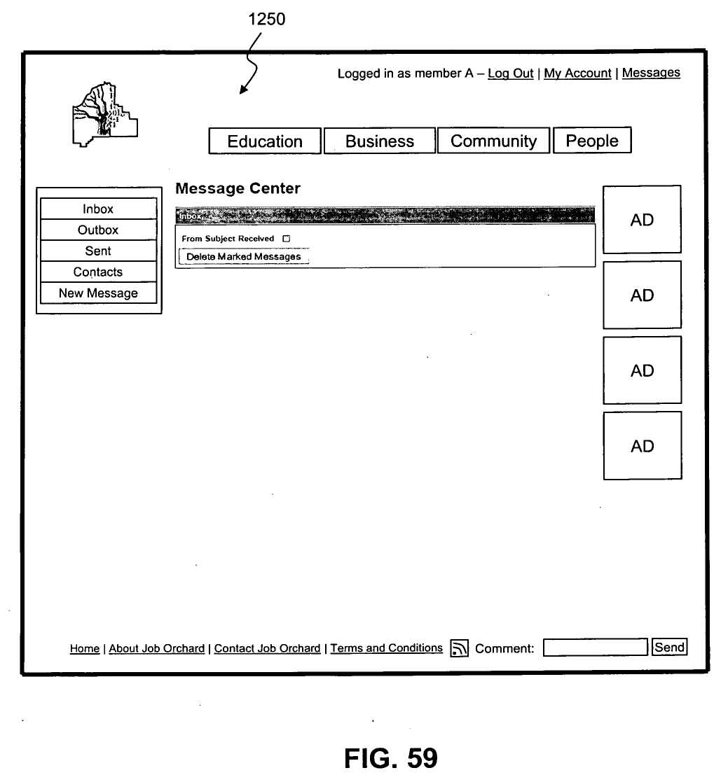

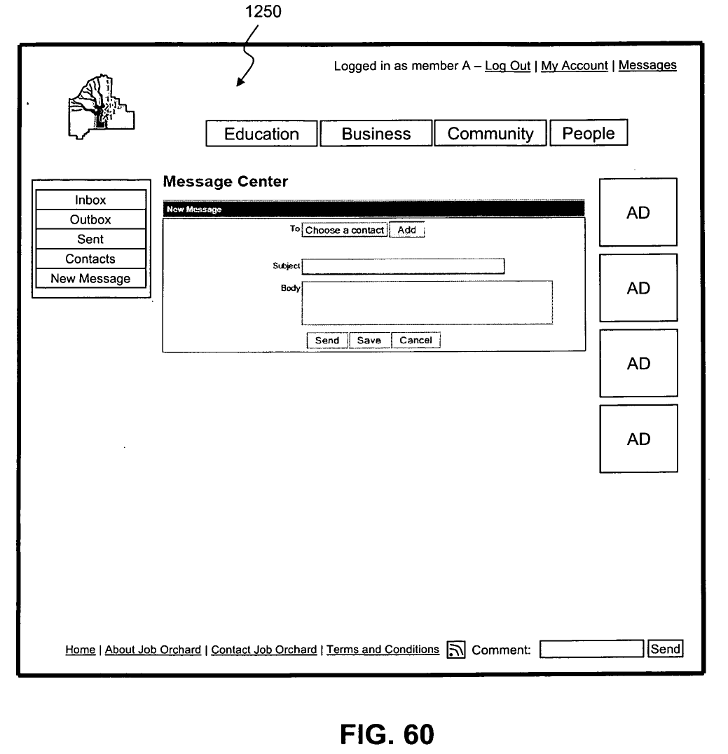

Referring to FIG. 9, a main portal screen 300 of the business portal user interface presented on display 126 of computing device 120 is shown. main portal screen 300 includes across the top an indicator 302 that member A is logged in to online community 100, a selection input 304 to logout of online community 100, a selection input 306 to navigate to a My Account user interface (see FIG. 58), and a selection input 308 to navigate to a Messages user interface (see FIGS. 59 and 60).

Main portal screen 300 further includes a community icon 3 10. In one embodiment, the online community 100, unlike the world wide web which is global, is generally established to correspond to a specific geographical or political boundary and to bring people, businesses, government, and organizations of that specific geographical or political boundary into an online community for interaction. Icon 310 has the shape of that specific geographical or political boundary. As such, community icon 310 provides an easy reference for the specific geographical or political boundary to which the online community corresponds.

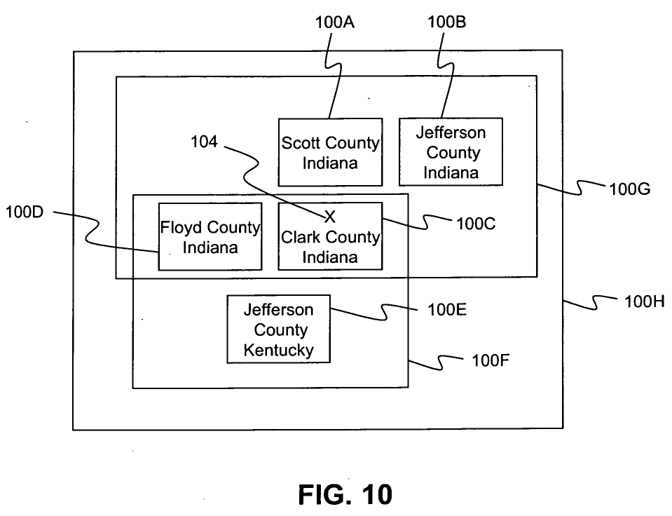

Referring to FIG. 10, it is contemplated to have multiple online communities which a computing device 120 is associated with and to which a member may logon. Exemplary online communities correspond to differing geographical or political boundaries: online community 100A corresponds to Scott County, Ind.; online community 100B corresponds to Jefferson County, Ind.; online community 100C corresponds to Clark County, Ind.; online community 100D corresponds to Floyd County, Ind.; online community 100E corresponds to Jefferson County, Ky.; online community 100F corresponds to the greater Louisville metropolitan area; online community 100G corresponds to the state of Indiana; and online community 100G corresponds to the Midwestern Unites States. A member 104 situated in Clark County, Ind. may be associated with each of online communities 100C, 100F, 100G, and 100H. In this manner anyone in any of those online communities will be able to interact with member 104. The shape of icon 310 provides an indication to member 104 which online community he is logged into at the present time.

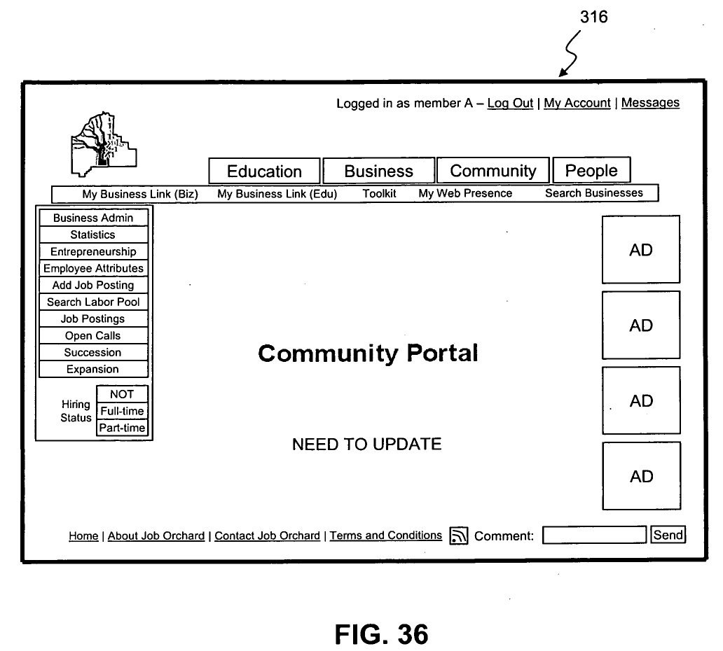

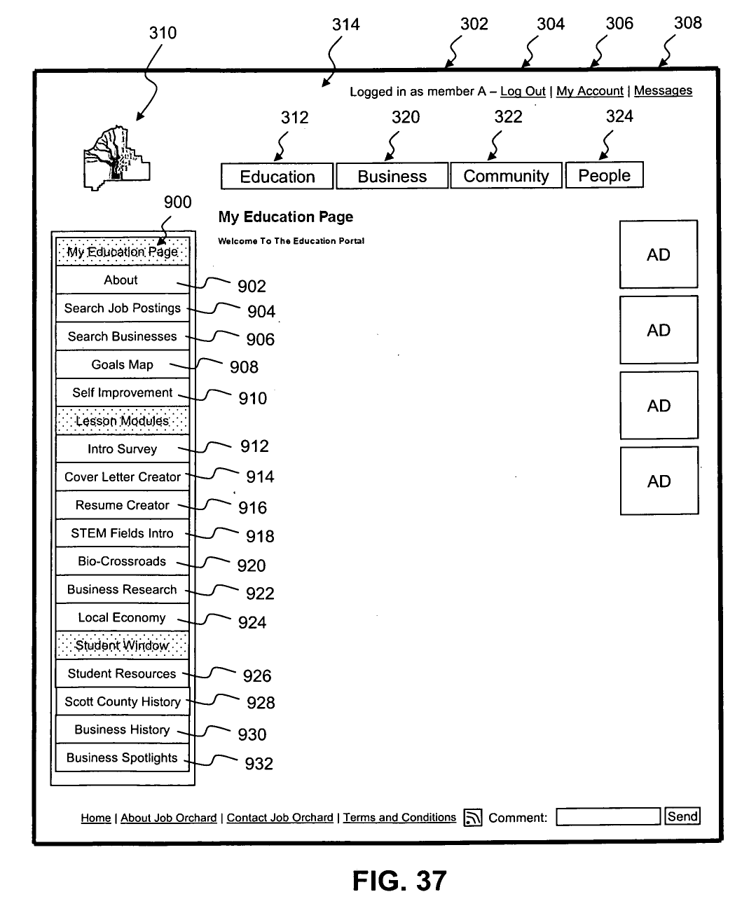

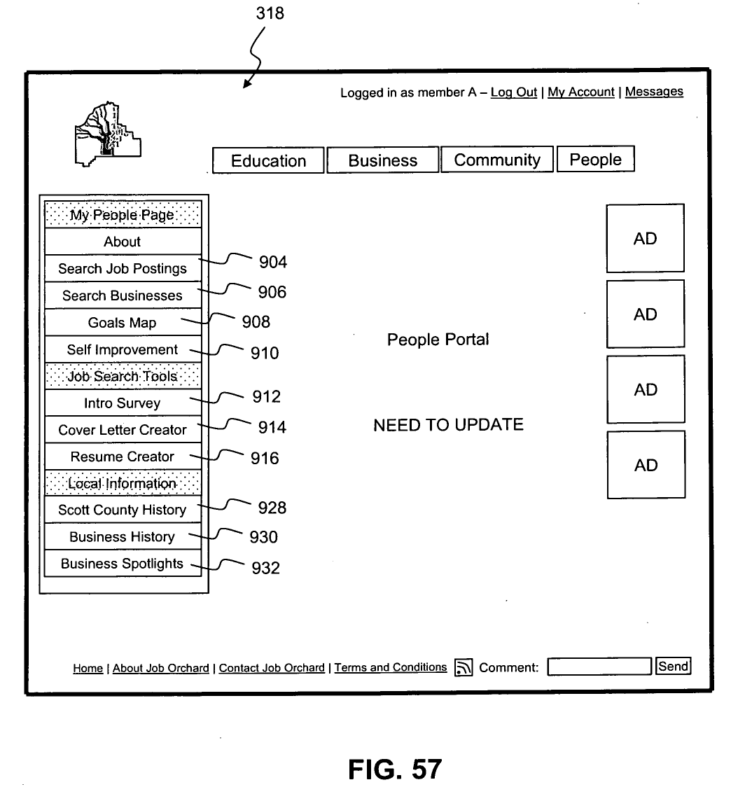

Returning to FIG. 9, selection input 312 navigates to an main portal screen 314 (see FIG. 37) of education portal 236. Selection input 320 navigates to a main portal screen 300 of business portal 232 (which is shown in FIG. 9). Selection input 322 navigates to a main portal screen 316 of community portal 238 (see FIG. 36). Selection input 324 navigates to a main portal screen 318 of people portal 234 (see FIG. 57).

Along a right side of main portal screen 300 are a plurality of display boxes 328, 330, 332, and 334 wherein advertisements are presented. In one embodiment, the advertisements presented in display boxes 328, 330, 332, and 334 are selected based on the provided interests of the member 104. In one embodiment, the advertisements are selected based on Adsense technology from Goolge located in Mountain View, Calif. and Business Solutions technology from Facebook located in Palo Alto, Calif.

In region 336 of main portal screen 300, a contact list 338 is provided. The contents of region 336 change based on the navigation inputs selected in main portal screen 300.

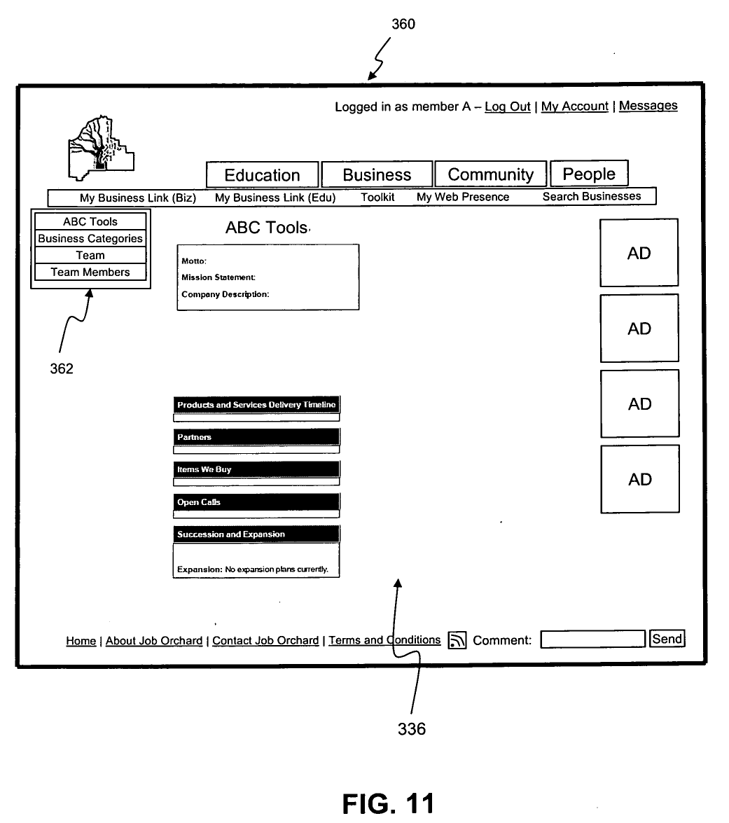

Five additional navigation inputs are provided across a top portion of main portal screen 300. First, a My Business Link (Biz) selection input 340 is provided. Selecting selection input 340 results in screen 360 (see FIG. 11) being presented. The information in region 336 is the information which would be viewable by other members 104 if they selected a business link input for ABC Tools from business portal 232. It should be noted that screen 360 further includes selection inputs 362 which take the viewer to further information about ABC Tools.

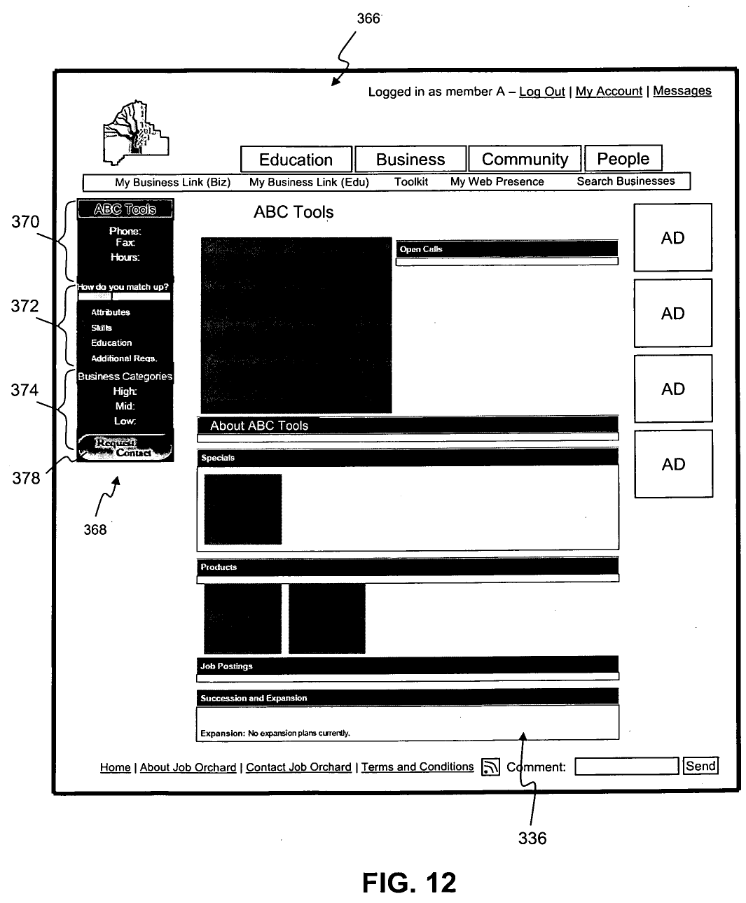

Second, a My Business Link (Edu) selection input 342 is provided. Selecting selection input 342 results in screen 366 (see FIG. 12) being presented. The information in region 336 is the information which would be viewable by other members 104 if they selected a business link input for ABC Tools from education portal 236. Along the left side of screen 366, contact information is presented in region 370, an evaluation of how well the viewer of screen 366 matches with the employment attributes of ABC Tools in region 372, business category information is provided in region 374, and a request contact input 378 is provided. In one embodiment, additional information is also provided, such as is the business currently hiring, is the business looking for a succession partner, and is the business contemplating an expansion. Consumer information is also available on My Business Page (Edu), allowing students to interact with the business as consumers. The evaluation of the viewer is performed by computing device 200 which matching criteria in a relational database, such as database 212. Exemplary criteria include skills, GPA levels, cognitive skill ability test scores (for example the WORKKEYS brand Foundation Skills assessments from ACT Corporation located in Iowa City, Iowa), and job behavior assessment test scores (for example the WORKKEYS brand Personal Skills assessments from ACT Corporation located in Iowa City, Iowa) The business categories relate to standard NAICS codes for Internal Revenue Service business classification. Selecting selection input 378 results in a message (for example, an e-mail, an automated voice message, a text message, and other suitable messages) being sent from the viewer to the business.

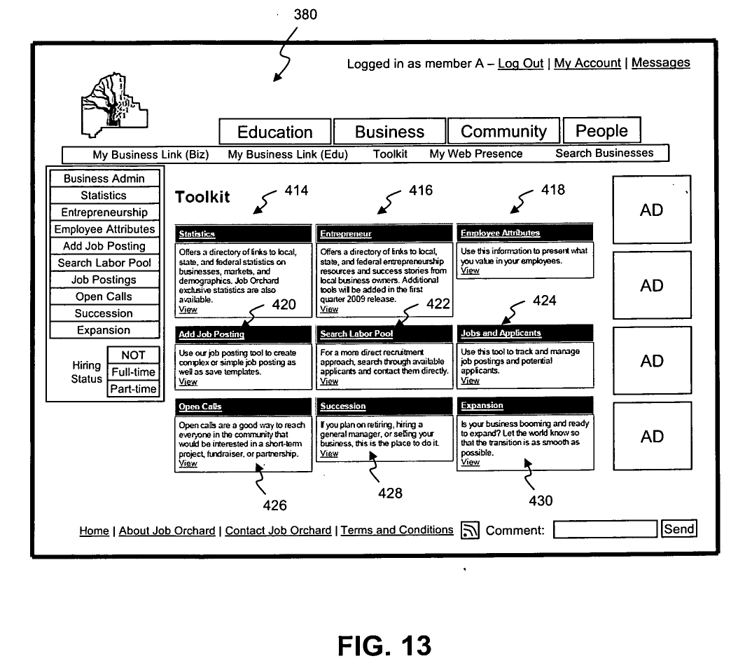

Third, a Toolkit selection input 344 is provided. Selecting selection input 344 results in screen 380 (see FIG. 13) being presented. Region 336 provides additional information for a plurality of business community applications and selection inputs for those business community applications. Referring to FIG. 5, exemplary business community applications include a business administration application 382 (selection input 412); a statistics application 384 (selection input 414); an entrepreneur application 386 (selection input 416);an employee attributes application 388 (selection input 418); a job posting application 390 (selection input 420); a labor pool application 392 (selection input 422); a jobs and applicants application 394 (selection input 424); an open call application 396 (selection input 426); a succession application 398 (selection input 428); and an expansion application 400 (selection input 430). Each of these business community applications is discussed herein. As shown in FIG. 13, redundant selection inputs are provided for many of the above-mentioned selection inputs along a left side of screen 380. The left side further includes a hiring status selection input 432. A user may select the appreciate selection input that corresponds to their current hiring status: selection input 434 for not hiring, selection input 436 for hiring full-time employees; and selection input 438 for hiring part-time employees. The results of selection input 432 are displayed on screen 366 and screen 440 for viewers of the ABC Tools links.

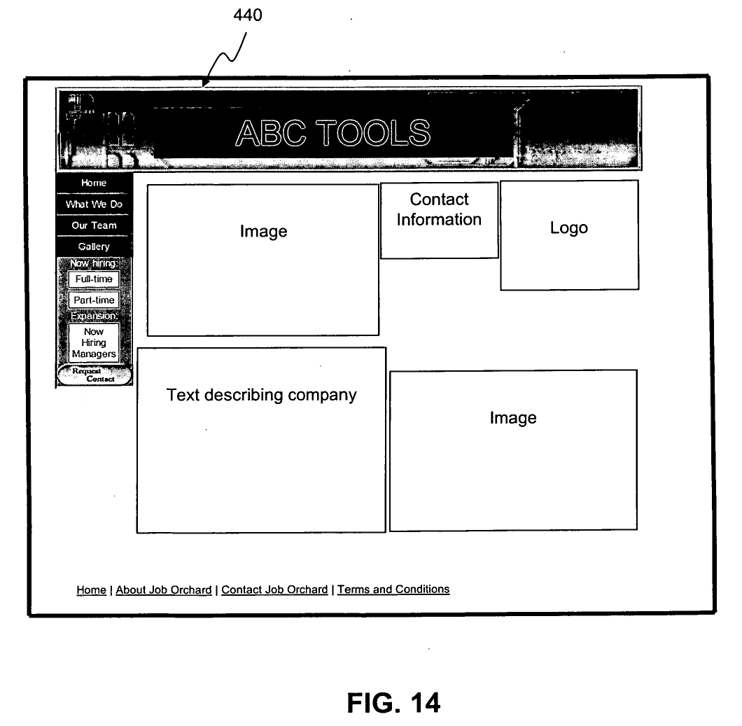

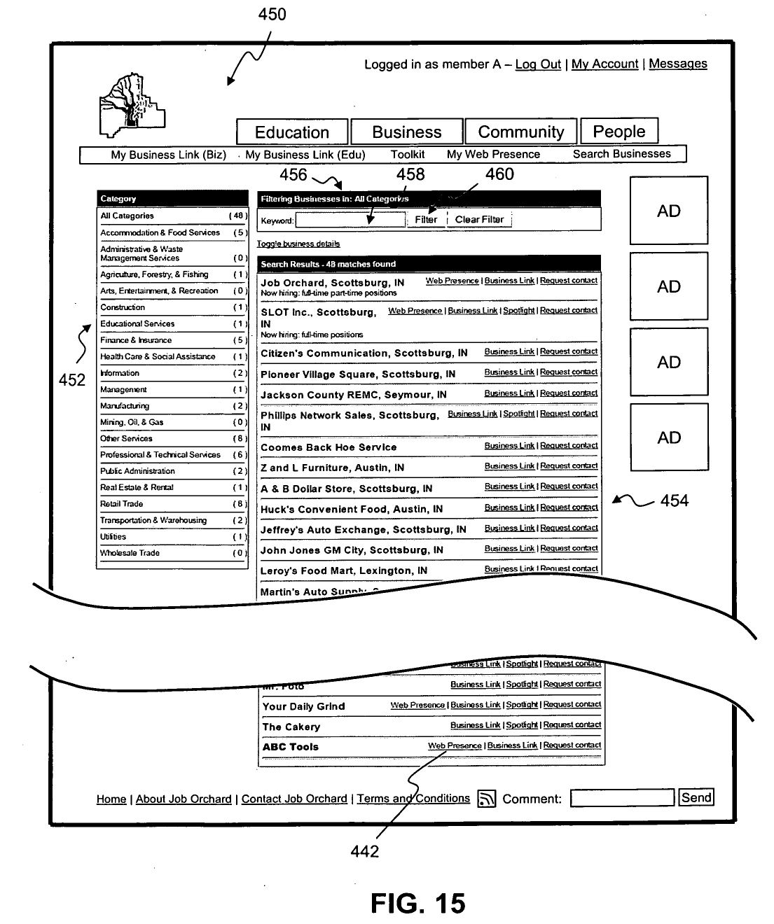

Fourth, a my Web presence selection input 346 is provided. Selecting selection input 346 results in screen 440 (see FIG. 14) being presented. FIG. 14 provides a web site for ABC Tools for all members of online community 100 to view. Screen 440 may be viewed by selecting a web presence link 442 for ABC Tools in a business listing (see FIG. 15).

Fifth, a search business input 348 is provided. Selecting selection input in screen 450 (see FIG. 15) being presented. In screen 450 all of the businesses associated with online community 100 are searchable. On the left side a category listing 452 is provided. Each category includes a numeric indicator of the number of businesses within that category. Each category may be selected by clicking on the name of the category. This results in the businesses in that category being displayed in a Search Results region 454 of FIG. 15. For each business listed in the search results region 454, a selection input is provided to that business's business link in the business portal 232 and a request contact input. The request contact input generates a message (for example, an e-mail, an automated voice message, a text message, and other suitable messages) to be sent to the business from the viewer. Also, if the business has a web presence, a selection input (for example 442) is provided. A search input 456 is provided on screen 450. A user inputs keywords in selection input 458 and selects input 460 to filter the search results for businesses that have the keywords specified. Boolean logic may be used for multiple keywords.

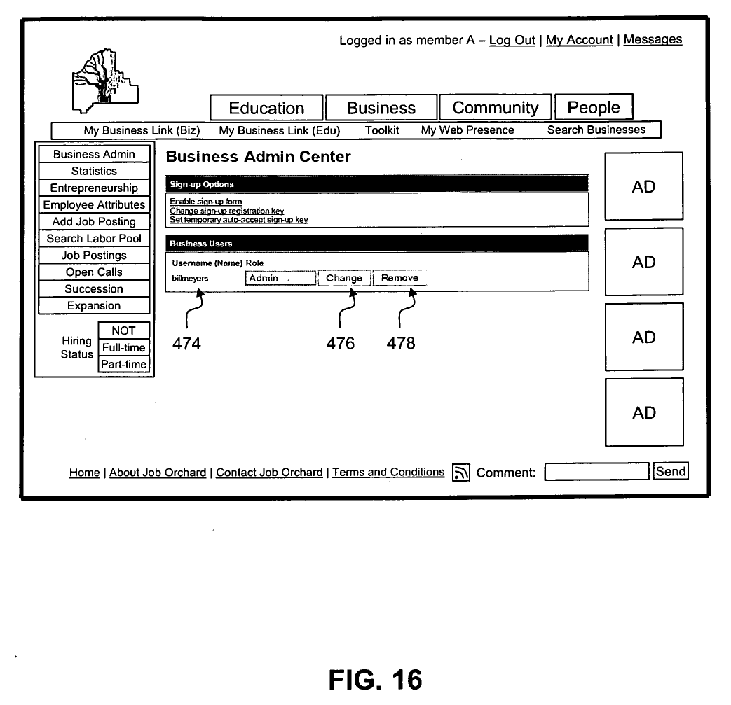

Referring to FIG. 16, a screen 470 is presented when business administration selection input 412 is selected. A sign-up options selection input 472 is provided. Further, a listing of business users (team members) is provided in region 474 along with a selection input 476 to change a role of the team member and a selection input 478 to remove the team member from being associated with the business.

Selecting statistics selection input 414 provides statistical information from various sources, including statistical information regarding members of online community 100 from databases 212. This information and/or links to external sites are provided in a screen (not shown). Selecting entrepreneurship selection input 416 provides entrepreneur information from various sources. This information and/or links to external sites are provided in a screen (not shown).

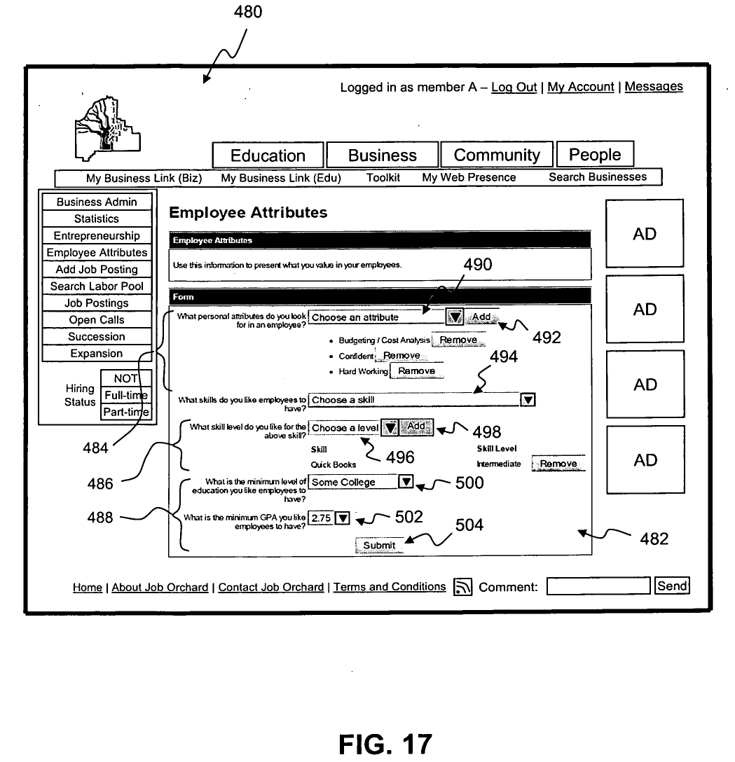

Referring to FIG. 17, a screen 480 is presented when employee attributes selection input 418 is selected. A form 482 is presented whereby a user may provide information regarding attributes that are desirable in employees for the business. In one embodiment, these attributes might to applicable to all employees. In one embodiment, these attributes are applicable to a specific employee category, such as, retail, manufacturing, research, engineering, warehousing, and other suitable categories. The user would have the ability to setup employee attributes for each employee category, if desired. Theses employee attributes are used in the evaluation process of the items in region 372 of FIG. 12. Computing device 200 compares the attributes of the viewer of screen 366 to the attributes provided through employee attributes application 388 to determine a level of matching which is displayed in region 372, as both a horizontal gauge and based on the categories of attributes, skills, and education.

Form 482 includes an attribute region 484, a skill region 486, and an education region 488. In attribute region 484, the viewer may select attributes from a drop-down listing 490 and add a selected attribute by selecting the add selection input 492. As illustrated three attributes have been selected. In skill region 486, the viewer may select skills from a drop-down listing 494, a skills level from a drop-down listing 496, and add a selected skill by selecting the add selection input 498. As illustrated a single skill has been selected. In education region 488, the viewer may select an education level from a drop-down listing 500 and a GPA level from a drop-down listing 502. The employee attributes may be saved by selecting input 504. This updates the employee attributes stored in database 212. As mentioned herein, the attributes may be tied to a specific employee category. in this case, an employee category would also be selectable in form 482. The comparison in region 372 of FIG. 12 would then provide a separate comparison for each specified employee category. By using predefined sets of attributes (in the drop-down list), predefined sets of skills (in the drop-down list), and predefined sets of education (in the drop-down list), the comparison with the attributes of community members is easier.

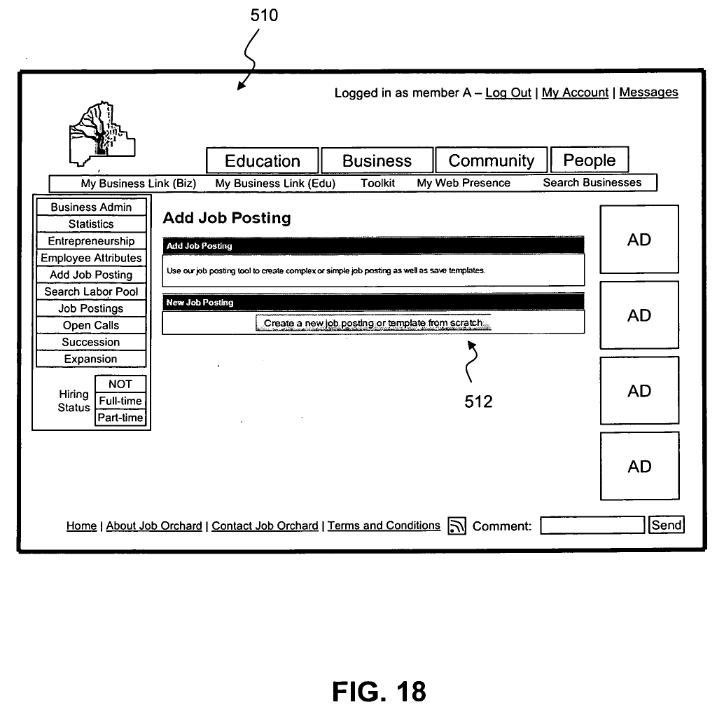

Referring to FIG. 18, a screen 510 is presented when job posting selection input 420 is selected. The job posting application 240 provides an employer with the ability to create an employment listing for members of the community to view and, if desired, apply for consideration. Also, the employment listing may be saved as a template for use with future posting to reduce the amount of information that is required to form the job posting.

A user selects selection input 512 to create a new job posting or job posting template. The selection of selection input 512 results in screen 516 being displayed. Screen 516 includes a job posting creation guide 518. Portions still to be completed have an unfilled circle. Portions completed have a filled circle of a first color. The current portion being displayed in a region 520 has a filled circle of a second color.

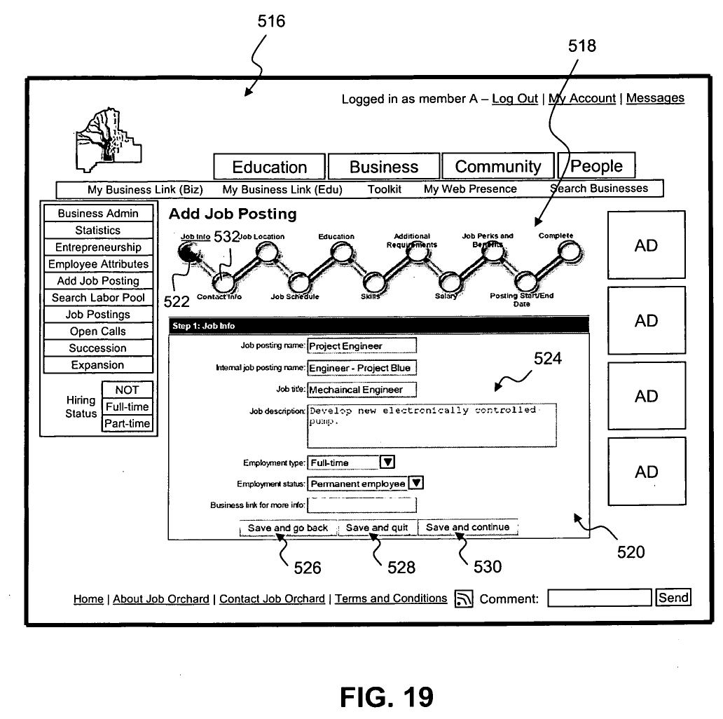

In FIG. 19, a job information portion 522 is shown. Various fill in fields are provided to describe aspects of the job. The business link input provides the ability to specify a web address or other address where more information about the job may be found. The viewer of screen 516 completes the various fill in fields 524 and selects one of the three selection inputs at the bottom. Selection input 526 saves the job posting in database 212 and returns to the immediate prior portion in the guide 518. Selection input 528 saves the job posting in database 212 and exits the job posting creation process. The process can be resumed at a later time. Selection input 530 saves the job posting in database 212 and proceeds to the next portion in the guide 518.

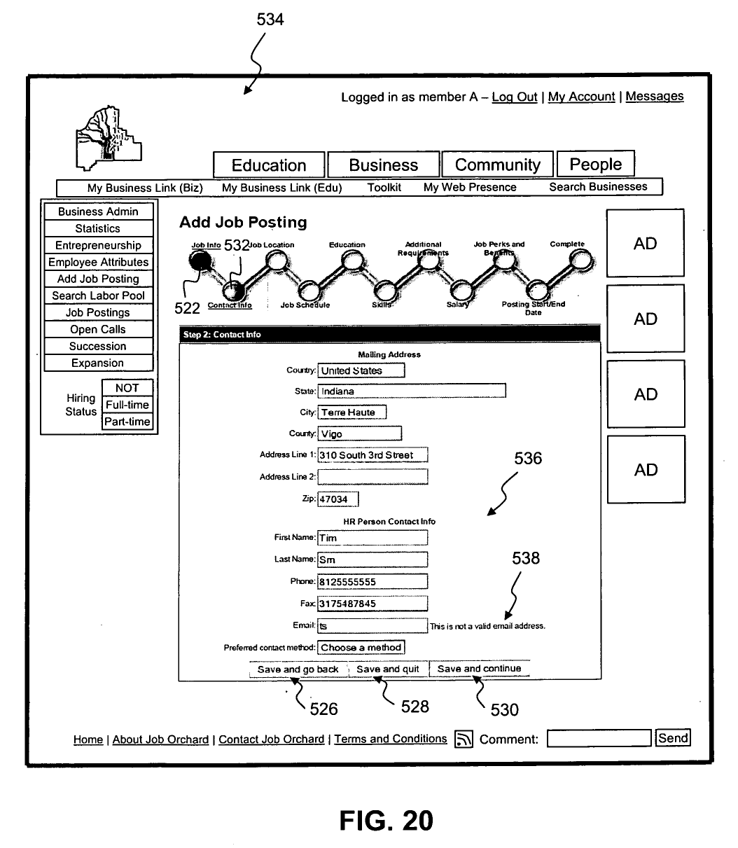

In FIG. 20, a contact information portion 532 is shown in screen 534. Various fill in fields are provided to specify contact information for applicants of the job. The viewer of screen 534 completes the various fill in fields 536 and selects one of the three selection inputs 526, 528, and 530 at the bottom. For fields which have a known form, computing device 200 provides a textual label indicating that the currently entered text 538 does not match the expected form for that field.

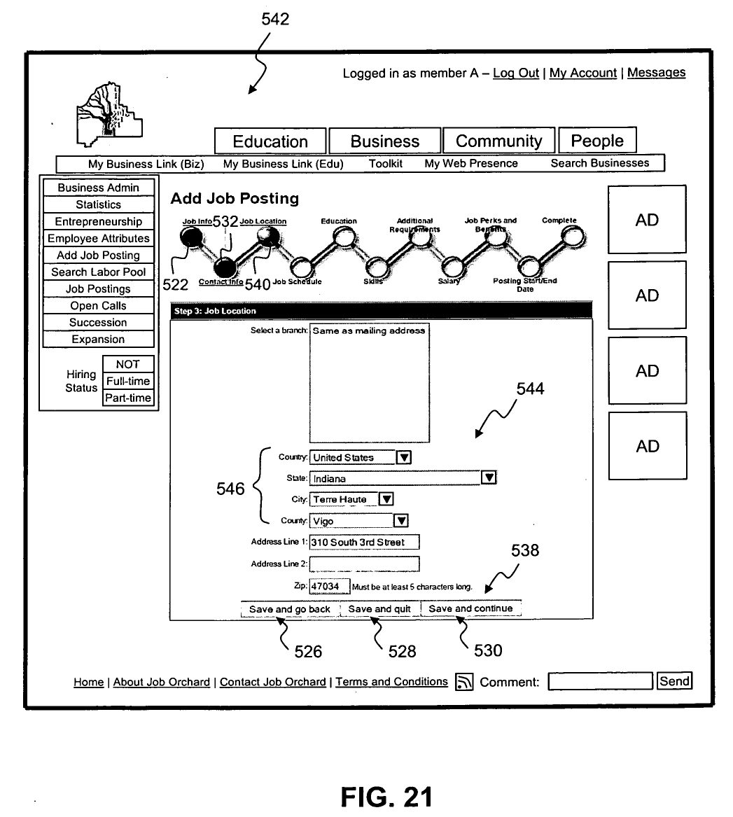

In FIG. 21, a job location portion 540 is shown in screen 542. Various inputs are provided to specify job location information. The viewer of screen 542 completes the various inputs 544. Inputs 546 are drop-down inputs have a predefined listing of possible selections to facilitate matching of job postings to job search inquiries. The user then selects one of the three selection inputs 526, 528, and 530 at the bottom.

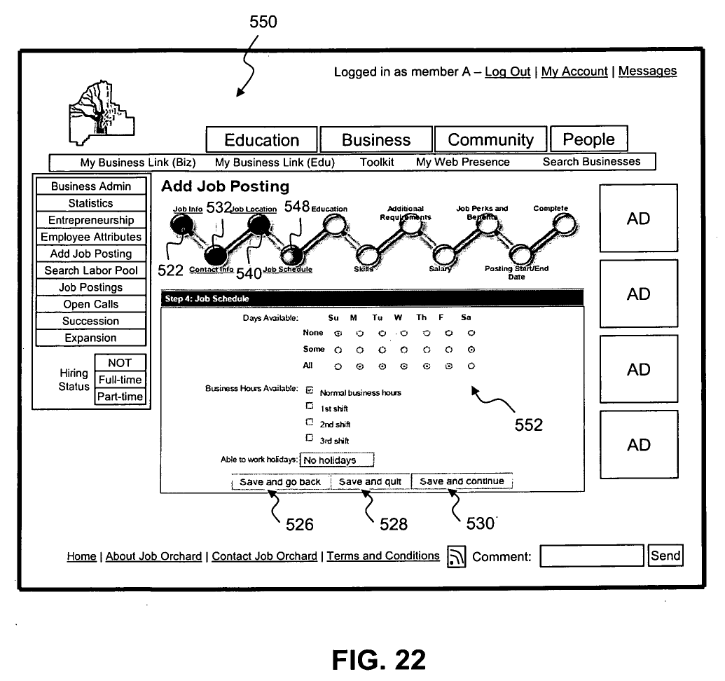

In FIG. 22, a job schedule portion 548 is shown in screen 550. Various inputs 552 are provided to specify job schedule information. The viewer of screen 550 completes the various inputs 544. Inputs 552 have a predefined set of possible selections to facilitate matching of job postings to job search inquiries. Inputs 552 permit an employer to specify a schedule for each day of the week, for hours of the day, and need to work holidays. The user then selects one of the three selection inputs 526, 528, and 530 at the bottom.

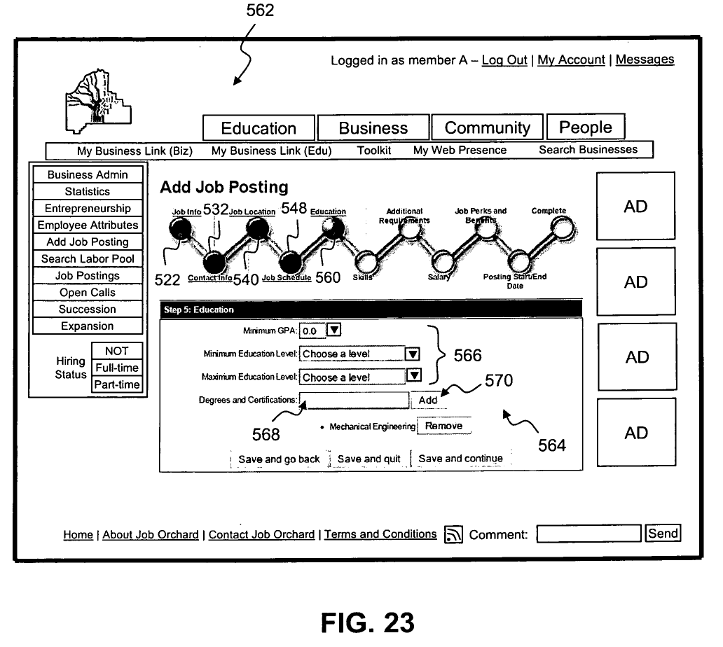

In FIG. 23, an education portion 560 is shown in screen 562. Various inputs 564 are provided to specify education information. The viewer of screen 562 completes the various inputs 544. A first portion 566 of inputs 564 have a predefined set of possible selections to facilitate matching of job postings to job search inquiries. An input 568 is a fill-in form and allows a user to specify a degrees for certification that is suggested. Input 570 adds the degree or certification to the job posting. The user then selects one of the three selection inputs 526, 528, and 530 at the bottom.

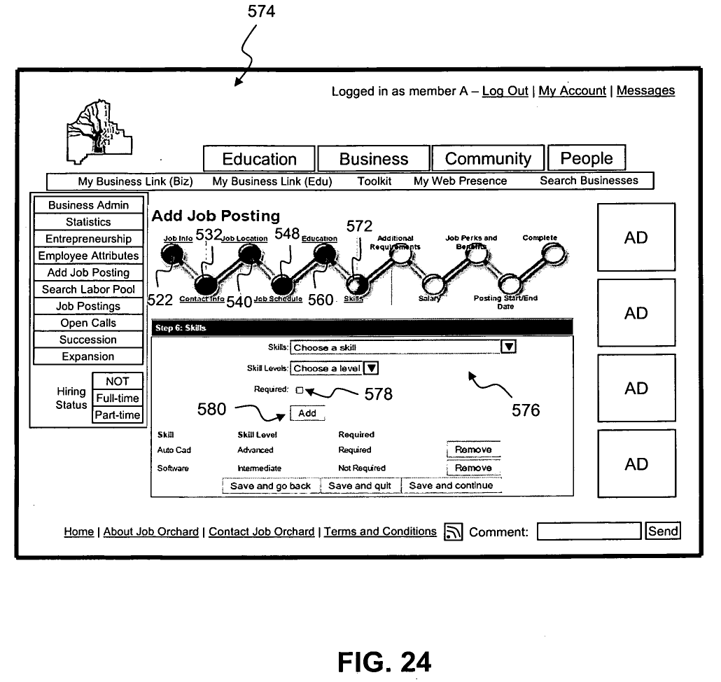

In FIG. 24, a skills portion 572 is shown in screen 574. Various inputs 576 are provided to specify skills information . The viewer of screen 574 completes the various inputs 576. Inputs 576 have a predefined set of possible selections to facilitate matching of job postings to job search inquiries. Inputs 576 include a check box 578 to specify whether a skill is required for the job or not. Input 580 adds the skill to the job posting. The user then selects one of the three selection inputs 526, 528, and 530 at the bottom. Illustratively, two skill have bee n added to the current job posting.

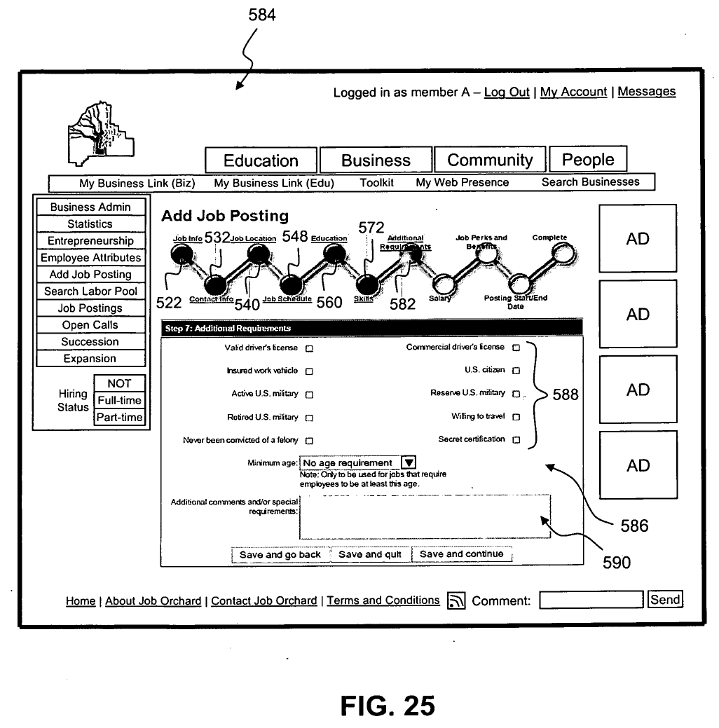

In FIG. 25, an additional requirements portion 582 is shown in screen 584. Various inputs 586 are provided to specify additional requirements information. The viewer of screen 584 completes the various inputs 586. A first portion 588 of inputs 586 have a predefined set of possible selections to facilitate matching of job postings to job search inquiries. An input 590 is a fill-in form and allows a user to specify additional comments and/or special requirements for the job. The user then selects one of the three selection inputs 526, 528, and 530 at the bottom.

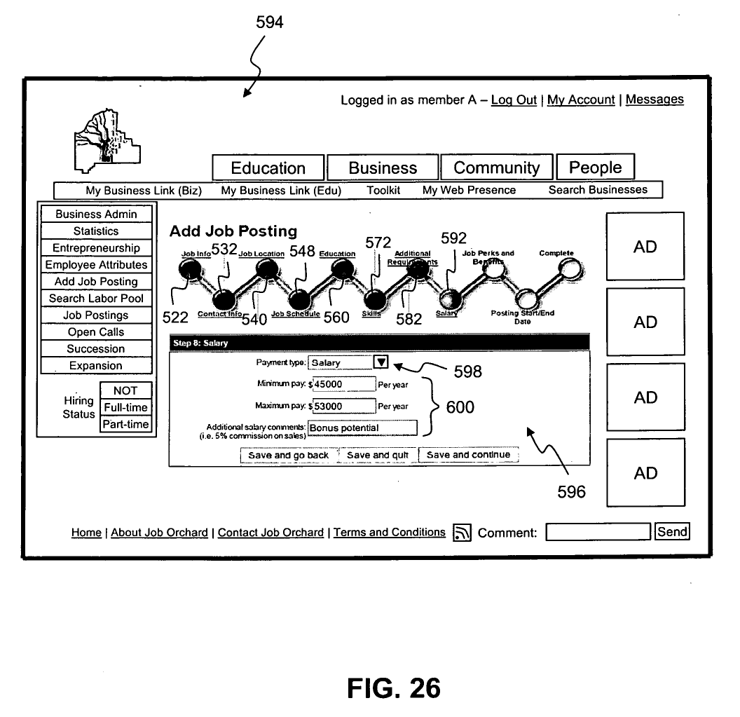

In FIG. 26, a salary portion 592 is shown in screen 594. Various inputs 596 are provided to specify salary information. The viewer of screen 594 completes the various inputs 596. A first portion 598 of inputs 596 have a predefined set of possible selections to facilitate matching of job postings to job search inquiries. Inputs 600 are fill-in forms and allow a user to specify a salary range and additional compensation for the job. The user then selects one of the three selection inputs 526, 528, and 530 at the bottom.

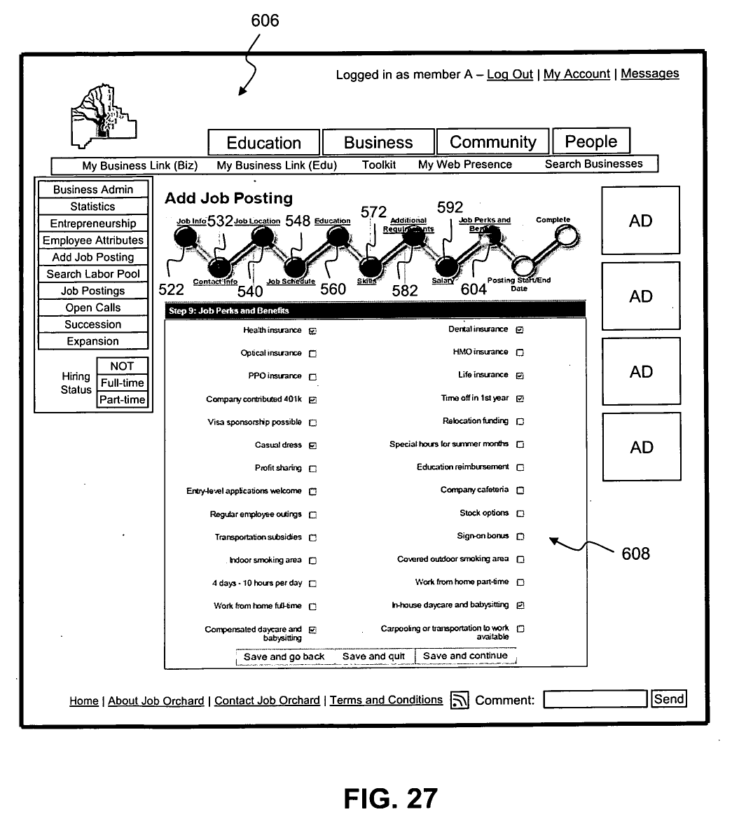

In FIG. 27, a job perks and benefits portion 604 is shown in screen 606. Various inputs 608 are provided to specify job perks and benefits information. The viewer of screen 606 completes the various inputs 608. Inputs 608 have a predefined set of possible selections to facilitate matching of job postings to job search inquiries. The user then selects one of the three selection inputs 526, 528, and 530 at the bottom.

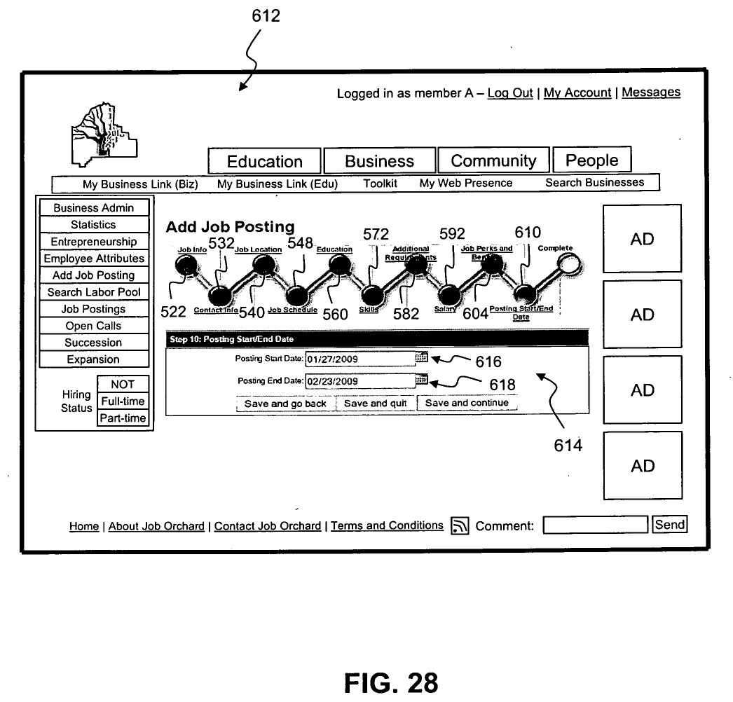

In FIG. 28, a job posting duration portion 610 is shown in screen 612. Various inputs 614 are provided to specify job duration information . The viewer of screen 612 completes the various inputs 614. A first calendar expander input 616 is provided to select the job posting start date. A second calendar expander input 618 is provided to select the job posting end date. The user then selects one of the three selection inputs 526, 528, and 530 at the bottom.

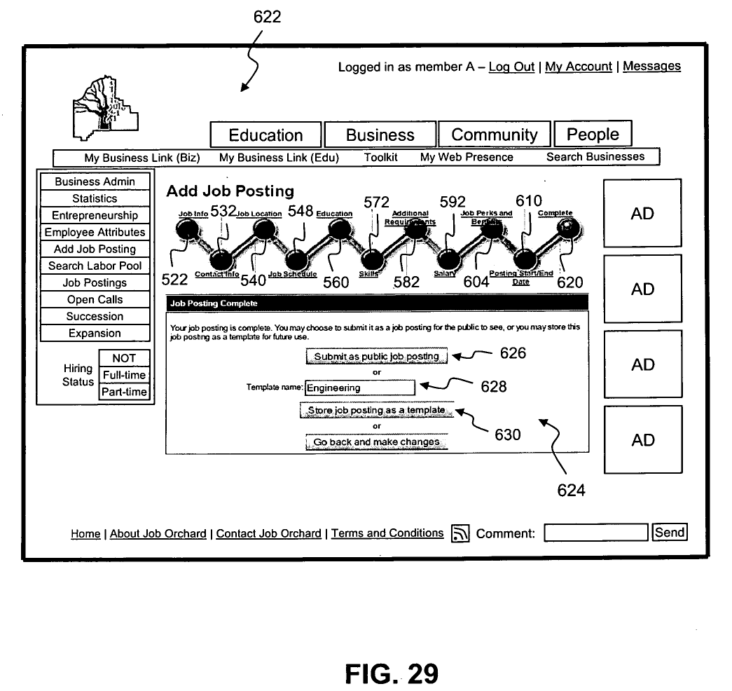

In FIG. 29, a job posting complete portion 620 is shown in screen 622. Various inputs 624 are provided to specify how to proceed with the job posting. Input 626 submits the job posting to the online community for review by other members 104. If the job posting is to be saved as a job template, a template name is specified with input 628 and the job posting is stored in database 212 when input 630 is selected. Finally, an input 632 is provided to navigate back to the proceeding section and make changes.

In one embodiment, an automated job posting routine is available. In one embodiment, memory 210, such as database 212, includes information regarding a particular business. Exemplary information includes business categories that the business is associated with. Exemplary business categories include sales, retail, manufacturing, research, engineering, warehousing, and other suitable categories. Further exemplary information includes information about desired employee skills, types of positions within the company, and attributes regarding those positions. In one embodiment, the exemplary information is stored in one or databases 212 in memory 210.

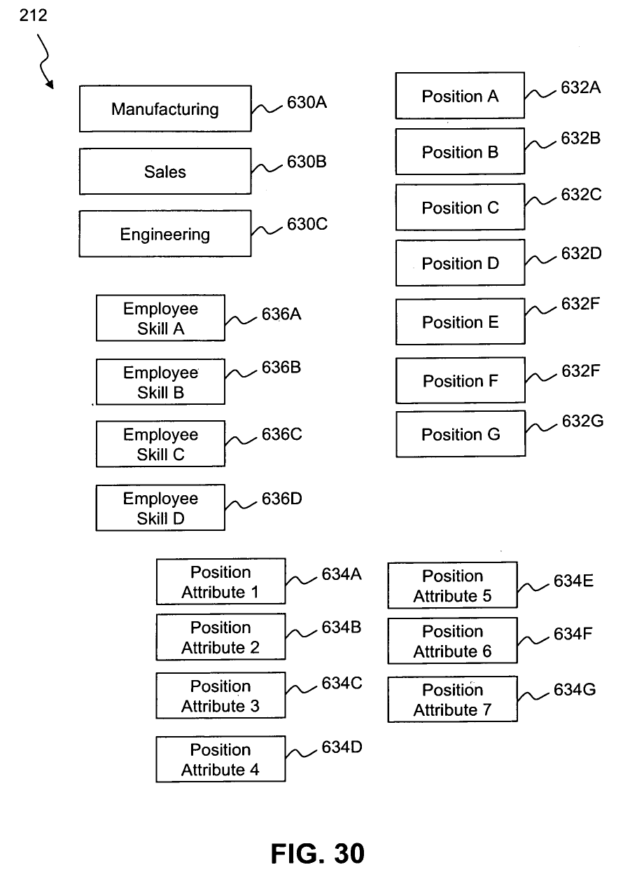

This stored information may be used to in generating posting for new job openings for a given company. Referring to FIG. 30, exemplary information for a first business is represented. The business has three associated business categories 630A-C, manufacturing, sales, and engineering. Within those three business categories 630A-C there are seven position types 632A-G. Some of the position types may be associated with only a single business category while other position types may be associated with two or more business categories. For instance, an administrative assistant position may be associated with all three business categories 630A-C meaning for each category one of the possible positions for a job posting is an administrative assistant position. Further, seven position attributes 634A-G are represented. These position attributes may be position 632 or category 630 specific or apply to multiple positions 632 and categories 630. Exemplary position attributes include full time, part time, education level, and other suitable attributes. Finally four employee skills 636A-D are represented. Exemplary employee skills include typing speed, prior experience, and other suitable attributes.

In one embodiment, a new job posting may be generated in the following manner. Once generated the job posting is available for the users of any of portals 232, 234, and 236. To generate a new job posting a representative of the business through business portal 232 requests to post a new job posting. Job posting application 390 receives and processes the request. Job posting application 390 generates a web page or instructions for a web page to be presented through business portal 232. In one embodiment, the web page inquires about a given position attribute 632 for the new posting. Of course, the web page may present an inquiry about any of the business information, such as business category. In one example, the inquiry is whether the position is a full time position or a part time position. Job posting application 390 receives back an indication of the selection and determines what business categories or positions are identified with the selection. For example, assume the selection was for part time. The business information might indicate that category 630A and 630B include positions with a potential part time attribute associated therewith. As such, job posting application 390 presents an inquiry regarding whether the new job posting is for category 630A or 630C. In one embodiment, for a given selection all of the possible employee attributes 636, positions 632, and position attributes 634 meeting a given selection are presented. The stored business information is used to populate a given job posting.

In one embodiment, a business representative, simply clicks or selects a part-time, or a full-time quick posting through business portal 232. This creates a general job posting for the company using generalized information and can be accomplished within seconds of logging in to business portal 232. Then a detailed posting is created from business information stored on memory 210. Instead of picking through every possible category, skill, and position available, the business has all of the pertinent categories filled from the database and must only sort through their business's subset of previously selected general employee skills to create the job posting.

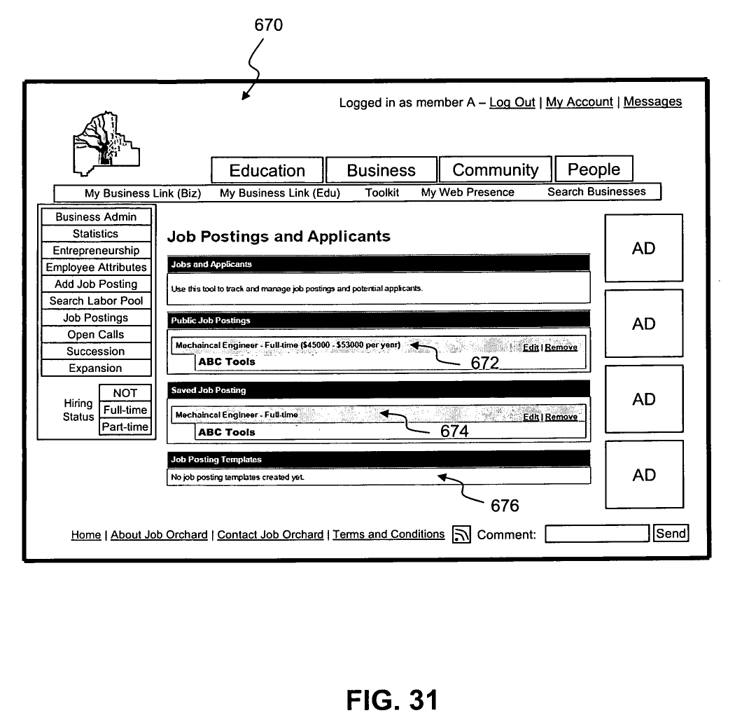

Referring to FIG. 31, a screen 670 is presented when job posting and applicants selection input 424 is selected. The job posting and applicants application 394 provides an employer with the ability to review current job posting, saved job postings, and job posting templates. Current public job postings are listed in region 672. If applicants had applied to the job, they would be listed here as well along with a link to review their information. Saved job postings are listed in region 674. Saved job posting templates are listed in region 676.

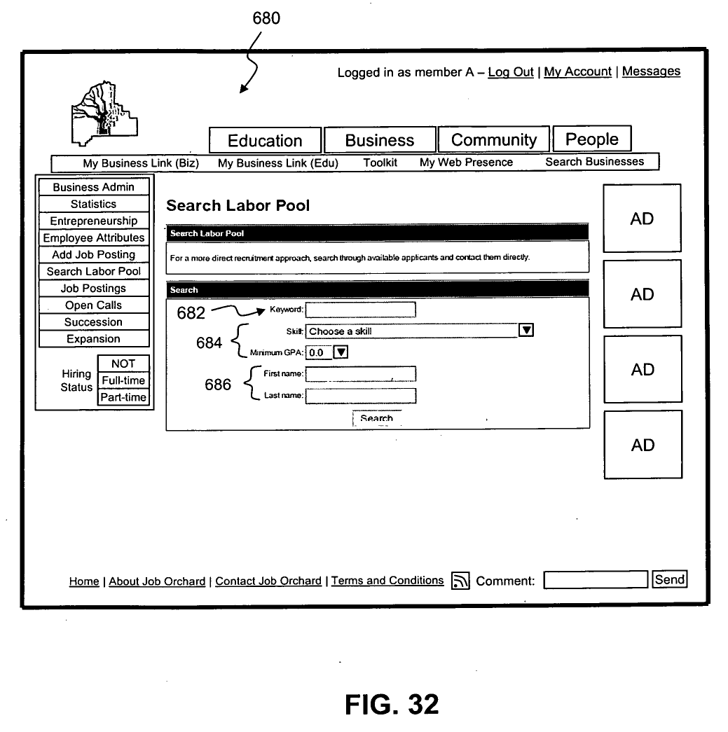

Referring to FIG. 32, a screen 680 is presented when search labor pool selection input 422 is selected. The labor pool application 392 provides an employer with the ability search the members of online community 100 for potential candidates that satisfy a criteria. The viewer of screen 680 is able to enter a keyword with selection input 682 or a name through selection inputs 686. The viewer of screen 680 is able to select predefined skills and GPA with selection inputs 684. Computing device 200 searches database 212 for members of the online community that satisfy the inquiry.

The labor pool evaluation application 392 permits a business to search the active labor pool to determine to search for community members that satisfy various criteria. The business owner may then contact the community members to gauge their interest in an employment or other opportunity. In one embodiment, the labor pool evaluation application 392 permits a business to search a reserve labor pool to determine the ability to have community members to relocate to a specific region if an opportunity existed. Additional details regarding a reserve workforce application is described in U.S. patent application Ser. No. 12/195,913, filed Aug. 21, 2008, titled METHOD AND APPARATUS FOR WORKFORCE ASSESSMENT, docket JORCH-P0001-01, the disclosure of which is expressly incorporated by reference herein.

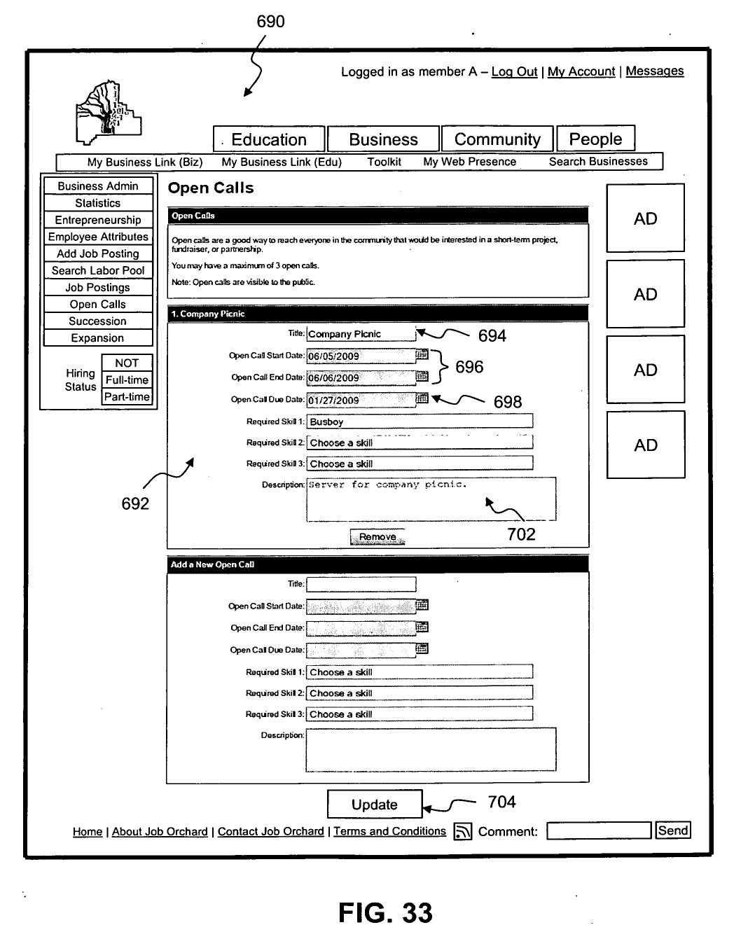

Referring to FIG. 33, a screen 690 is presented when open calls selection input 426 is selected. Open calls are a good way to identify members of the community that may be interested in a short-term project, fundraiser, or partnership. A business may have up to three open calls active at any one time. Referring to FIG. 33, the business has entered an open call for a busboy at the company picnic. This may be a good opportunity for a high school student to earn some extra money. The user specifies a name for the open call through input 694 and a start date and end date through inputs 696. An open call due date is specified with input 698. The user is ability to select predefined skills from database 212 through inputs 700. A description of the open call may be entered with input 702. finally, the open call may be updated through input 704.

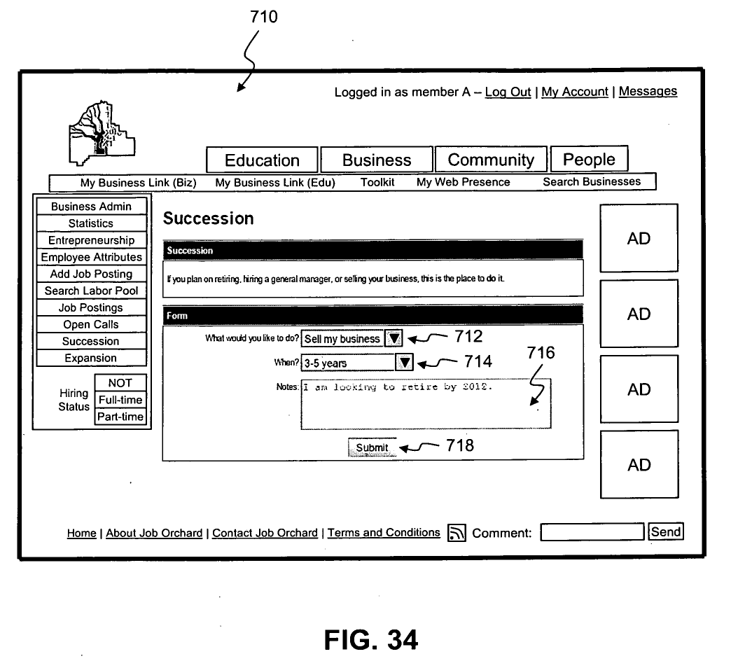

Referring to FIG. 34, a screen 710 is presented when succession input 428 is selected. The business succession application 244 permits a business to plan for a future retirement or departure of a business owner or leader. Referring to FIG. 34, the viewer of screen 710 has selected with input 712 from a group of predefined selections that he wants to sell his business. Another predefined selection is to hire a manager. the viewer has also selected with an input 714, the timetable by which he wants to sell his business and has provided notes with input 716. This may be a good opportunity for someone looking to get involved with a company for a couple of years and then purchase the company, maybe a business major at college. The succession plan may be saved in database 212 and viewable by others by selecting input 718.

The disappearance of local businesses in rural portions of the United States is an issue. This disappearance is evident in the food service and retail sectors as chains establish themselves in the local market, but also applies to many other business types, such as manufacturing. The business succession application 244 allows local business owners preparing for retirement, moving, or going out of business to contact learners or residents who have indicated an interest in entrepreneurship and offers them the opportunity to learn about the business and ease succession. The business succession application 244 allows the current owner of a business to train a new generation of local talent to take over the business.

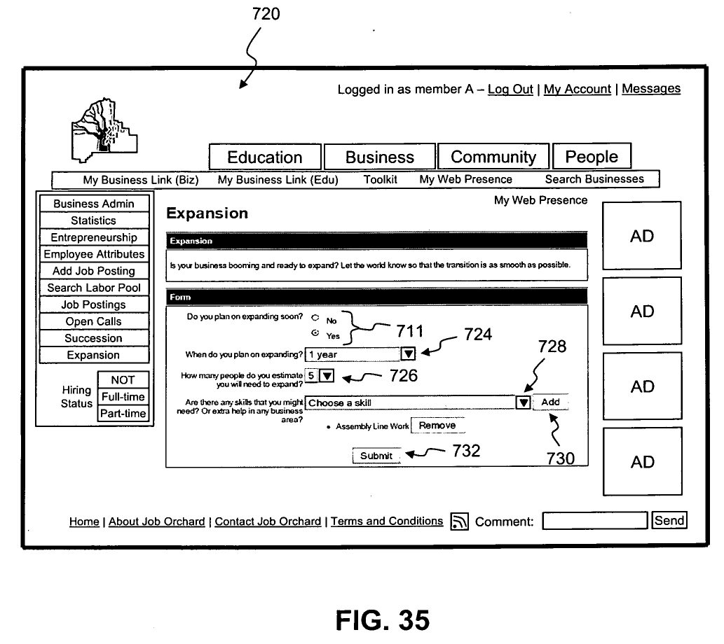

Referring to FIG. 35, a screen 720 is presented when expansion input 430 is selected. The expansion application 400 permits a business to plan for a future expansion of the business. Referring to FIG. 35, the viewer of screen 710 has selected with input 722 from a group of predefined selections whether they plan on expanding soon. With selection input 724, the viewer is able to specify a timeframe from a predefined listing of timeframes. With selection input 726, the viewer is able to specify a number of people needed for the expansion. With selection input 728 the viewer is able to specify a skill from a listing of predefined skills that would be needed by potential employees. Each skill selected may be added with input 730. illustratively the skill assembly line work has already been added. The expansion may be saved in database 212 and viewable by others by selecting input 732.

An example of how a small business may use business portal 232 and its application follows. The business owner logs into online community 100. He receives an alert in the message center 308 that one of his employees has requested a day off. He clicks the alert and accepts the request which is then stored in a personnel scheduling application 399 (see FIG. 5). A message is sent to the employee's phone and email account (which are stored in database 212) verifying the date.

The owner decides to change the images and text on his homepage to match the season. He clicks on the web presence input 346 and with a web presence application 401 (see FIG. 5) changes the images and text. He hits submit and the page updates instantly. While the owner is on his web editor, he chooses to add a new item to his online store. He snaps a digital image, adds product details and inventory information, and loads the new product onto his page (this information is stored in database 212).

Web site management completed, the owner decides to search for a summer intern. He has a job posting set up and he checks the queue of applicants and applicants application 394. He tags a few. They move to the top of the list and are highlighted. However, he is not satisfied and so proactively searches through the resumes of the local high school seniors through the labor pool application 392. He finds a couple matches and sends a note to the students.

He glances at his logo. He really wants a new one, but does not know where to look. He clicks on Open Call input 426, and chooses graphic art as the category. He enters a description of what he wants. He hits send. Every student and business in the area with an interest in graphic art (skill in predefined list of 728) receives the opportunity.

At this point he checks on the progress of two of his employees who are taking computer classes at the local learning center through education portal 236. One of them has completed the class, the other is still three sessions away. He goes to the message center 308 and contacts the employee who has not finished the class.

The last thing he needs to finish that morning is scheduling an open house. He wants to make sure that it does not interfere with other events to get as many people to come as possible. He clicks on the Community Portal 238 and sets the filters so he sees school events, sporting events, business events, and government events. He picks a day, enters a description, and adds a great picture that he took at the last open house. He posts the event. After a little debate, he decides that he wants some real world advertising as well. He hits advertise and clicks the Red Post (Goshen, Ind. www.theredpost.com) option. He purchases ads for three weeks at all locations. Now his open house image and info will show up at the BMV, Wal-Mart's entrance, and around the courthouse square.

### Community Portal

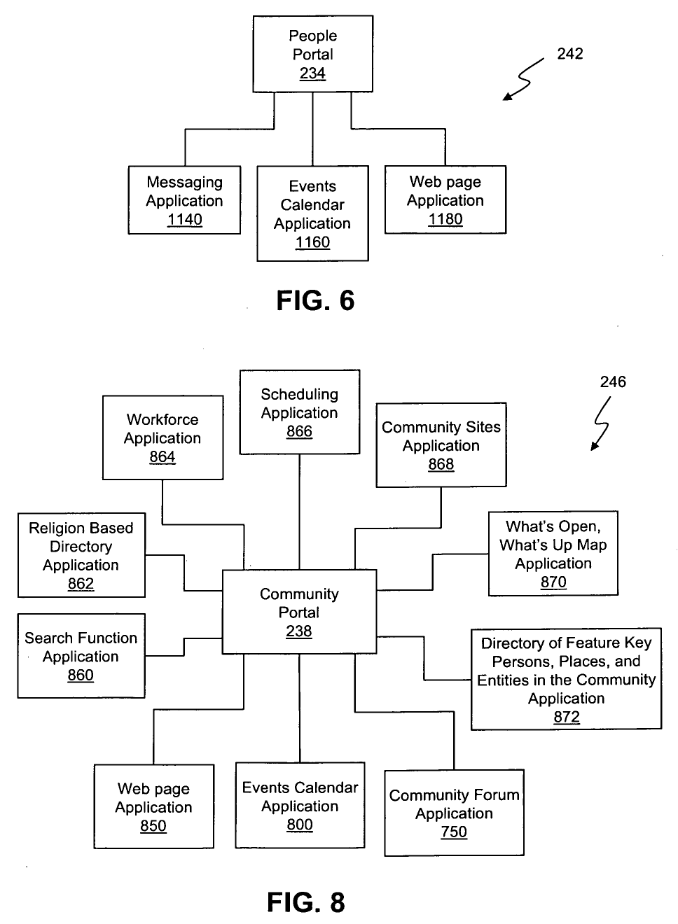

Community portal 238 provides information related to the community and includes information which is stored in databases 212. Community portal 238 provides access to multiple community applications 246. Referring to FIG. 6, exemplary community applications 246 are represented.

A first exemplary community application is a community forum application 750. The community forum application 800 provides a place for members of the community to post ideas for consideration by others. The community forum will be enriched by syncing it with several other Community tools, like the events calendar.

A second exemplary community application is an events calendar application 800. The events calendar application 800 provides a place for community groups to post information about upcoming events in the real world community associated with the online community. The events calendar allows the poster to relate the posted event to users' interests, hobbies, previous activities, places of employment, or geographic area. Users which have an onsite tracked behavioral history or self-reported interest in the event are then advertised the event. The events calendar will also come with an online scheduling utility allowing users to manage multiple events, including scheduling event attendance between peers, i.e. your friends will be able to see events you're planning to go to or show interest in Statistics will be gathered after events to report to event holders.

A third exemplary community application is a web page application 850. The web page application 850 provides community organizations with the ability to post information about themselves, images, audio, and video on a web page viewable by the community. This application functions in the same manner as the aforementioned Web Presence in the Business Portal, but it is custom-tuned for entities within a community. Certain features and built-in tools will be different.

A fourth exemplary application is a search function application 860 for community services such as alcohol prevention, abuse prevention, or community assistance. Users will be able to quickly access a host of community resources by either browsing by category, clicking on one word, or searching. This service will be streamlined as much as possible to get instant help, such as the number for police, fire dept, etc. Because the online community will have so many community entities tied together in one place, a user needing help preventing further drug abuse may be able to be connected to a councilor online instantly, of such a community entity existed to provide that service.

A fifth exemplary application is a religion based directory application 862 which allows users to view the activities, sermons, or mission of community religious institutions.

A sixth exemplary application 864 (workforce application) is the utilization of the Workforce Database and Reserve Workforce Database as described in U.S. patent application Ser. No. 12/195,913, filed Aug. 21, 2008, titled METHOD AND APPARATUS FOR WORKFORCE ASSESSMENT, docket JORCH-P0001-01, the disclosure of which is expressly incorporated by reference herein. An authorized official, such as an economic development director, may use the system to message interested individuals who have exited the real world community and wish to return.

A seventh exemplary application is a scheduling application 866 for classes and seminars held by community minded-institutions.

An eighth exemplary application is the community sites application 868, allowing members of a real-life community to experience and discover places in their community online, in an informative, exciting, interactive environment. Users can even report sites of interest for Job Orchard to research. This application will be used heavily with the Education Portal. Job Orchard feels that it's important to educate these students pertaining to their environment, to encourage them to get involved in the maintenance of their historical landmarks, environment, and historical societies. This will show students that their community is a place to work for. These landmarks will be interactive—users will be able to explore them online, and will be encouraged to go there themselves, take pictures or video of the area, and post them to job orchard will a blog or vlog of their experiences, and this can become a part of the interactive environment.

A ninth exemplary application is the What's Open, What's Up “Map” application 870. This map is a live view of a chosen city or area/region showing all the shops that are open and all the events that are being held at the moment. The clock/date can be set ahead so that a user can plan his day. Entities will show “Open for X number of hours” countdown, and entities about to close will be color coded accordingly. This map is integrated with the events calendar and with each community entity's/business's web presence on Job Orchard. Short details about the entities may also be available on the map. The map may or may not be a true map on Job Orchard, and an API like Google Maps may be used.

A tenth exemplary application of the community portal is a directory of feature key persons, places, and entities in the community application 872. One planned project/feature is to record as many tales as possible from firsthand witnesses—getting the elders of the community to agree to be recorded on audio or video, or on paper if nothing else discussing various things of interest in their life in the county, including historical events. Plus, tales their parents or grandparents told them, as points of historical interest. Users can submit these items, or Job Orchard can acquire them. Users can rate this media. The average rating will dictate the prioritization.

When a user enters the Community Portal, a “My Community” page will open, filled with information fine-tuned to the user.

### Education Portal

Education portal 236 provides a learning environment for members of the online community and includes information stored in databases 212. Education portal 236 provides access to multiple community education applications 244. Business portal provides access to multiple community business applications 240 which are described in more detail herein. An exemplary listing of community business applications are provided in FIG. 5.

Referring to FIG. 37, a main portal screen 314 of the education portal user interface presented on display 126 of computing device 120 is shown. Main portal screen 314 includes across the top an indicator 302 that member A is logged in to online community 100, a selection input 304 to logout of online community 100, a selection input 306 to navigate to a My Account user interface (see FIG. 58), and a selection input 308 to navigate to a Messages user interface (see FIGS. 59 and 60).

Selection input 312 navigates to an main portal screen 314 (see FIG. 37) of education portal 236. Selection input 320 navigates to a main portal screen 300 of business portal 232 (which is shown in FIG. 9). Selection input 322 navigates to a main portal screen 316 of community portal 238 (see FIG. 36). Selection input 324 navigates to a main portal screen 318 of people portal 234 (see FIG. 57).

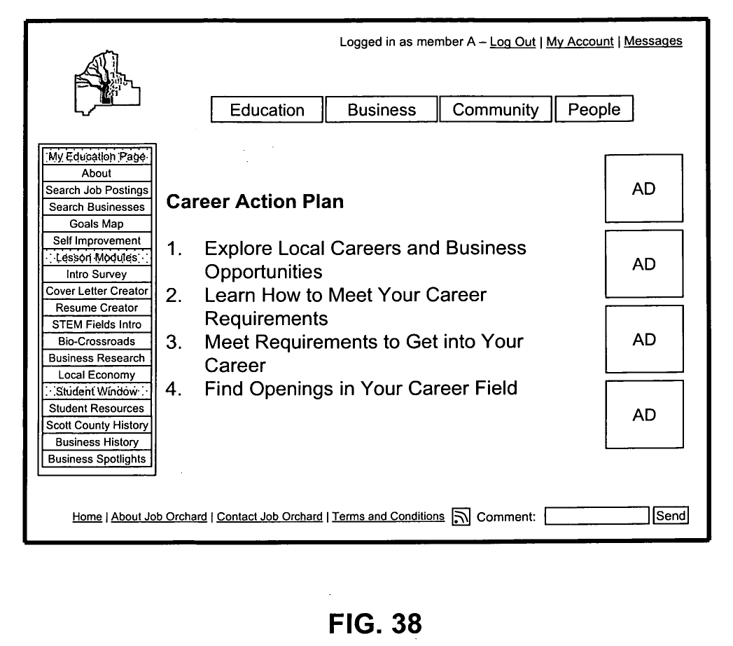

On the left side of screen 314 a listing of selection inputs for community applications 246 is provided. A first selection input 900 navigates to screen 314 (see FIG. 37). A second selection input 902 takes the viewer to a presentation on the goals of education portal 236, namely to establish a career action plan for students. In one embodiment, education portal 236 (1) allow a viewer to learn and explore local career and business opportunities; (2) learn how to meet her career requirements; (3) meet the requirements to get into a chosen career; and (4) find openings in her career field as specified in FIG. 38.

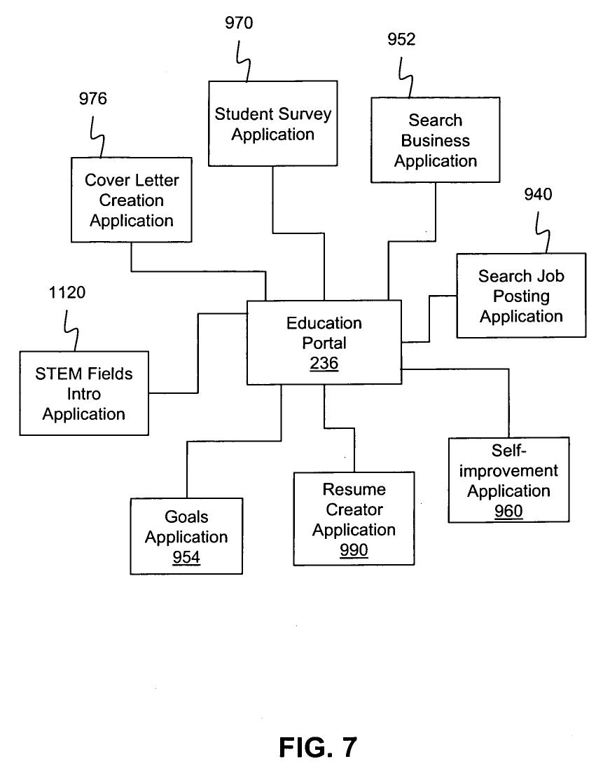

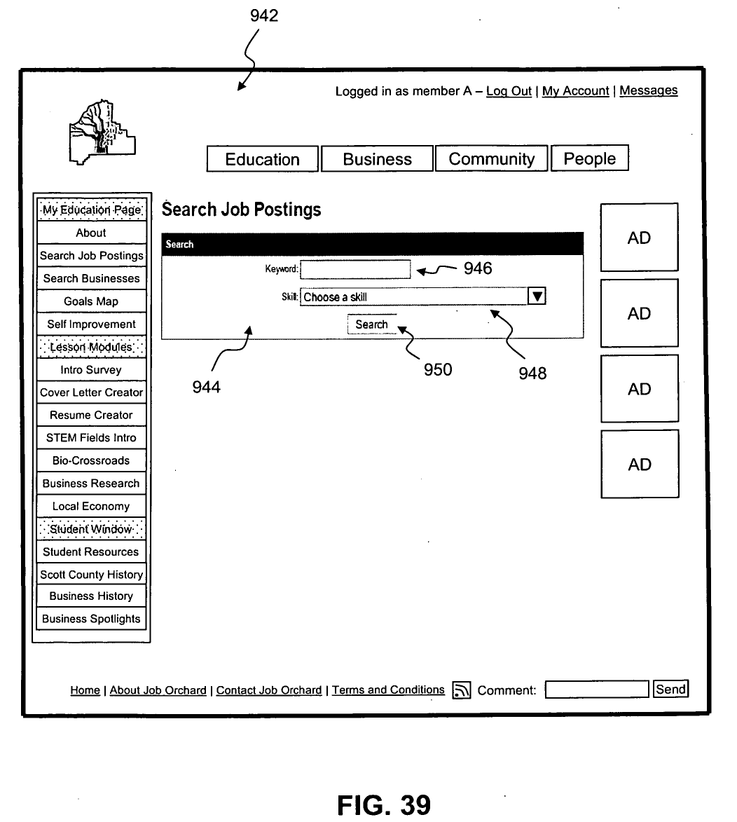

A second selection input 904 launches a search job postings application 940 (See FIG. 7). This navigates the viewer to screen 942 (see FIG. 39). Screen 942 includes a first region 944 wherein a user may specify parameters regarding a job posting to search. A first selection input 946 allows the user to specify keywords for which to search the job postings in database 212 for ones that include the keywords. A second selection input 948 allows the user to select a skill from a listing of predefined skills for which to search the job postings in database 212 for ones that include the skill. This is the same skill listing that is used by business members in the business portal.

A third selection input 904 launches a search businesses application 952. This takes the viewer to screen 450 (see FIG. 15).

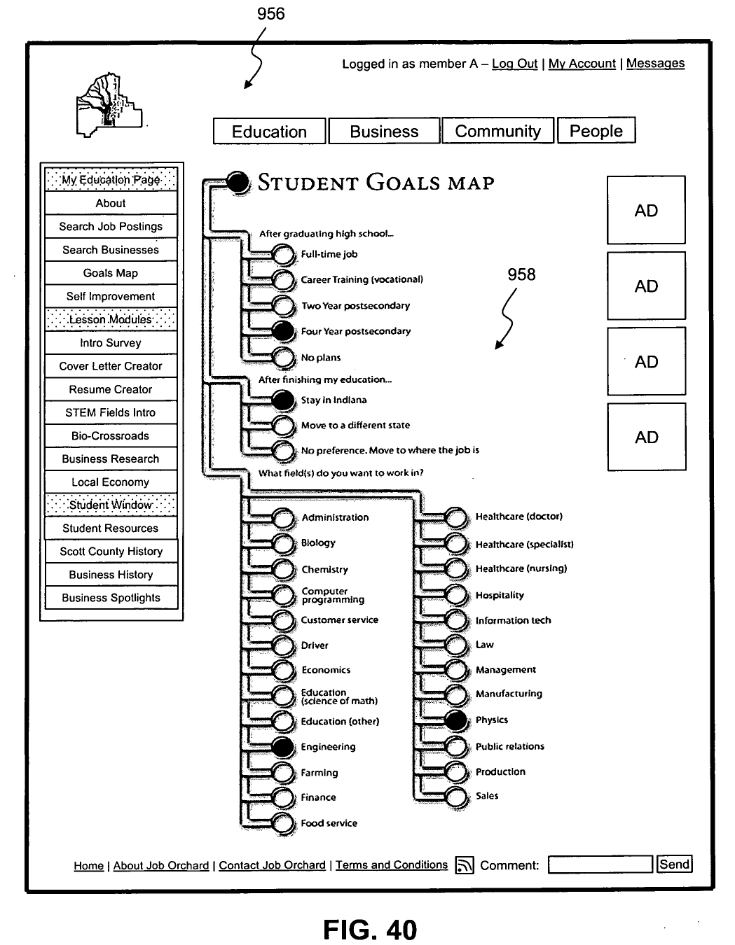

A fourth selection input 906 launches a goals application 954. The goals application 954 provides the results of an interactive survey (selected with input 912) and presents a pictorial representation of a member's goals. The selection of fourth selection input 906 navigates the viewer to screen 956 (see FIG. 40) which includes the pictorial representation of the results of the interactive survey taken by the student.

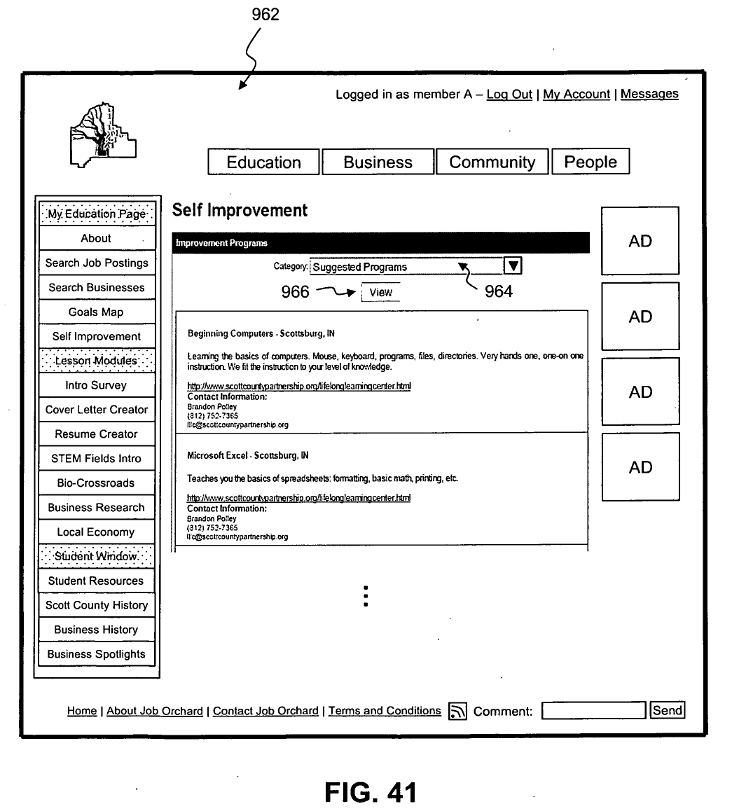

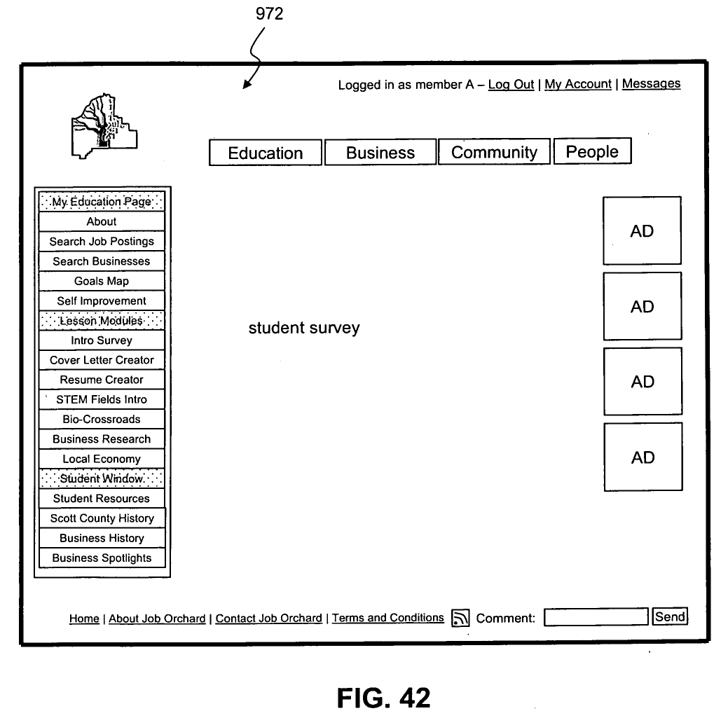

A fifth selection input 908 launches a self-improvement application 960. This navigates the viewer to screen 962 (see FIG. 41). The viewer with selection input 964 permits the viewer to select between suggested programs and programs related to a specific field. The viewer makes their selection with input 966. In one embodiment, the suggested programs are from education institutions which are members of the online community and have a web presence in the community portal 238. The suggested programs relate to assisting the viewer achieve their goals.

A sixth selection input 912 launches a student survey application 970. This navigates the viewer to screen 972 wherein the viewer is presented with a survey wherein the viewer answers a series of questions. An exemplary listing of survey questions and potential responses are provided below.

Survey Questions—potential responses in ( )

1. Gender: (Male, Female)

2. Ethnicity: (African American, Asian American, Caucasian, Latin American, Other)

3. Grade Level: (Junior, Senior)

4. Class Rank: (Top 5%, Top 10%, Top 25%, Middle 50-75%, Bottom 0-50%)

5. What is the highest degree either parent earned?: (Less than high school, High school, 2 year degree, 4 year degree, Masters, Doctorate)

6. After graduating high school . . . : (I plan to get a full-time job, I plan to receive some career training (vocational), I plan to attend a 2 yr postsecondary school, I plan to attend a 4 yr postsecondary school, I have made no plans after high school)

7. After finishing my education . . . : (I plan to stay in home state, I plan to move to a different state, No preference. I plan to move where I can get the best job.)

8. If you are planning to move, please fill out the following question: Why are you leaving your home state?: (I do not think there are opportunities for me in my home state, I do not like living in this region of the country, I do not like the people/culture in home state, Other)

9. Do you have access to a computer with internet access at home?: (Yes, No)

10. What is the combined income of your household? That is, how much do your parents make together?: (Under $22,000; $22,000-43,000; $43,000-70,000; and $70,000+)

11. Job (internship) preparation questions (which are answered Yes or No): Do you have a generic letter of application ready?; Do you have a professional-looking resume prepared?; Do you know how to dress for an interview?; Do you know how you will be required to dress at the job you want?; Do you feel prepared to decide what is best for you after high school?; Do you feel that your guidance counselors helped prepare you for life after high school?; Do you know what skills are needed at the job you want?; Do you know what skills/preparation would make you more valuable?; Do you know where to go for job and college information?; Do tests indicate you have good basic math skills?; Do tests indicate you have good basic English skills?; and Do tests indicate that you have good basic science skills?)

12. What is your strongest job-related selling point?

13. What is your weakest job-related attribute?

14. What field(s) do you want to work in? (Administration; Biology; Chemistry; Computer programming; Customer service; Driver; Economics; Education (science or math); Education (other); Engineering; Farming; Finance; Food service; Healthcare (doctor); Healthcare (specialized such as dentist); Healthcare (nursing, public health); Hospitality; Information technology; Law; Management; Manufacturing; Physics; Public relations and communication; Production; Sales; Science (other); and Other)

15. How many local companies do you know of that hire in your fields of interest? (0, 1-2, and 3+)

16. How well can you use a computer? Check all that apply. (I can program; I can edit photo/video/audio content; I am proficient in MS Office; I have basic computer skills; I can type well; and I am not familiar with computers)

17. How many years have you had a computer at home? (0, 1-2, 3-5, 6-9, 10-14, and 14+)

End of Survey Questions.

As mentioned herein at least a portion of the answers to these survey questions are used to generate the goals map pictorial representation 958.

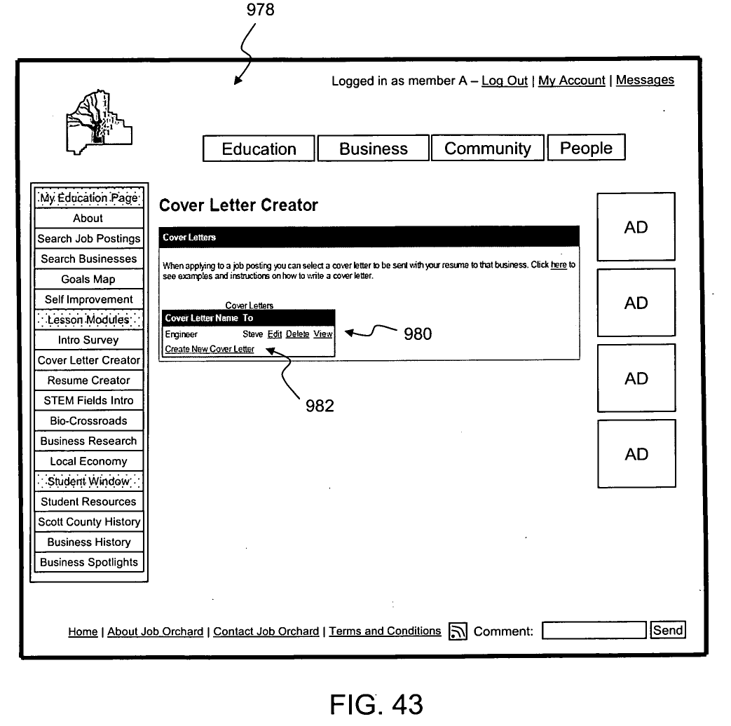

A seventh selection input 914 launches a cover letter creator application 976. This navigates the viewer to screen 978 (see FIG. 43) wherein the viewer is presented with a listing 980 of previously created cover letters for selection. Further, the viewer with selection input 982 may select to create a new cover letter.

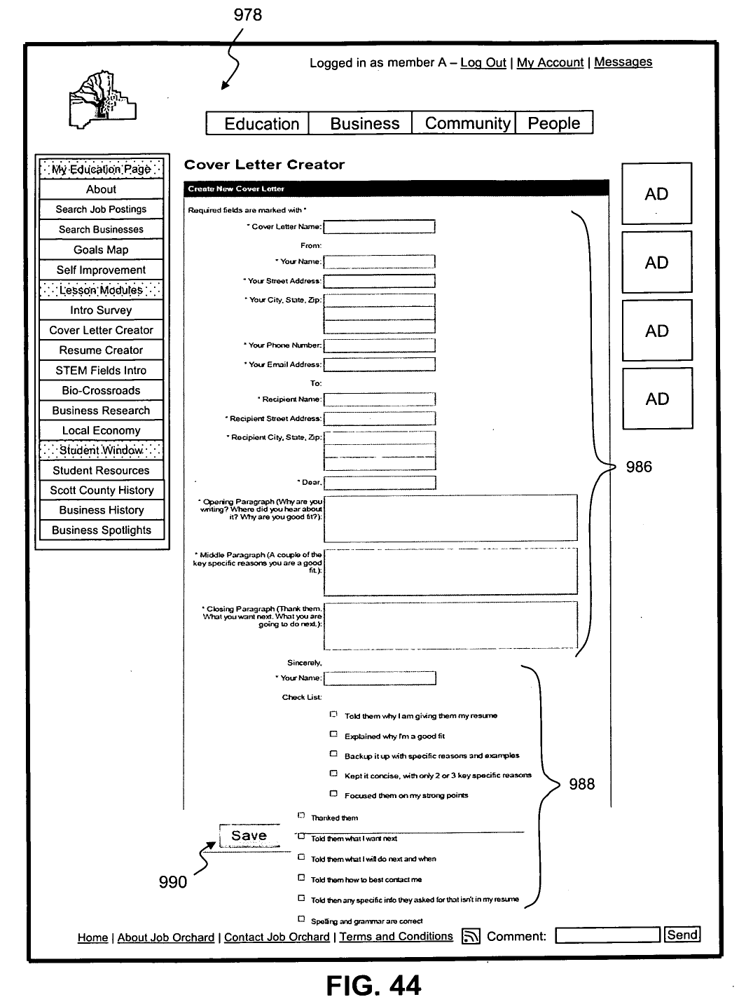

Selection of input 982 results in screen 984 (see FIG. 44) being presented to the viewer. Screen 984 includes a plurality of selection inputs 986 whereby a viewer is able to input the various portions of a cover letter. These portions may be subsequently formatted for opening as one of a word processing document and a pdf file. Screen 984 further includes a plurality of selection inputs 988 which provide a checklist for the viewer of pointers for a successful cover letter.

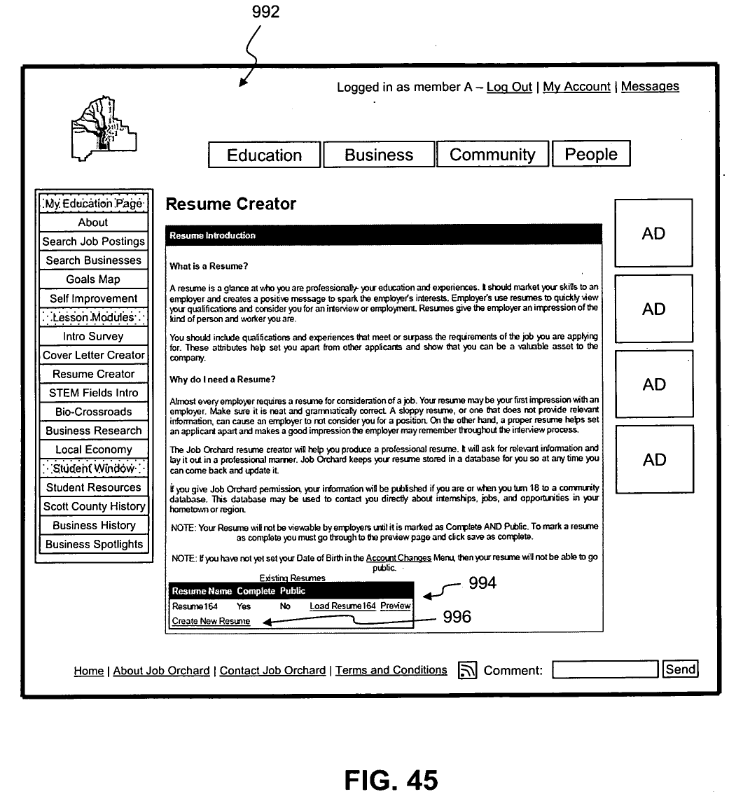

An eight selection input 916 launches a resume creator application 990. This navigates the viewer to screen 992 (see FIG. 45) wherein the viewer is presented with a listing 994 of previously created resumes for selection. Further, the viewer with selection input 996 may select to create a new resume.

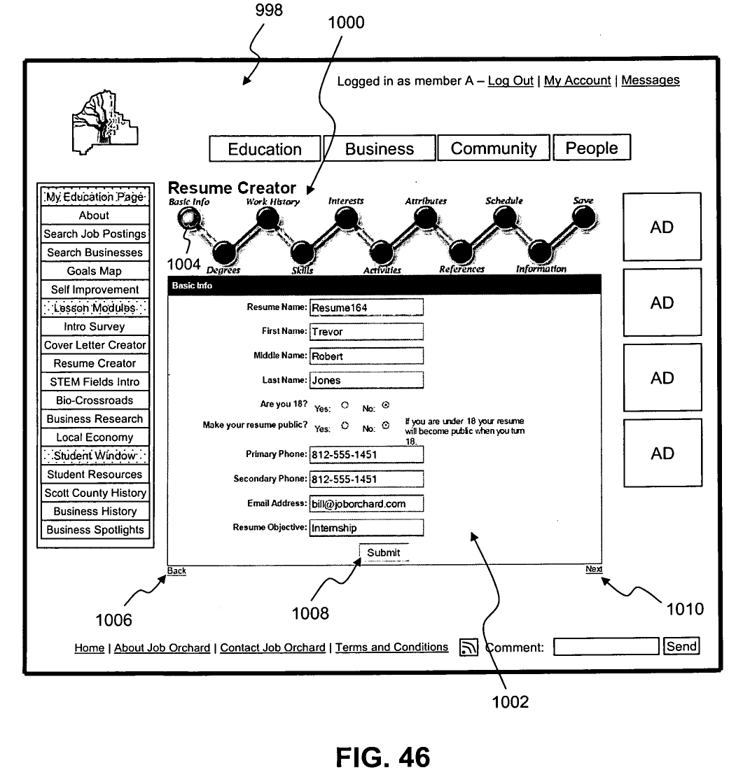

Selection of input 996 results in screen 998 (see FIG. 46) being presented to the viewer. Screen 998 includes a resume creation guide 1000. Portions of resume creation guide 1000 still to be completed have an unfilled circle. Portions completed resume creation guide 1000 have a filled circle of a first color. The current portion resume creation guide 1000 being displayed in a region 1002 has a filled circle of a second color.

In FIG. 46, a basic information portion 1004 is shown. Various fill in fields are provided to describe general contact information for the viewer, a name for the resume, and an objective of the resume. Further, the basic information includes selection inputs corresponding to the age of the viewer (18 and over or under 18) and whether the viewer wants their resume to be available to others in the online community. If the viewer is under 18 then they will have to fill out a permission form with their school in order for their resume to be allowed to be available to others in the online community. The viewer of screen 998 completes the various inputs and selects one of the three selection inputs at the bottom. Selection input 1006 saves the resume in database 212 and returns to the immediate prior portion in the guide 1000. Selection input 1008 saves the input in the current portion in database 212. The process can be resumed at a later time. Selection input 1010 saves the resume in database 212 and proceeds to the next portion in the guide 1000.

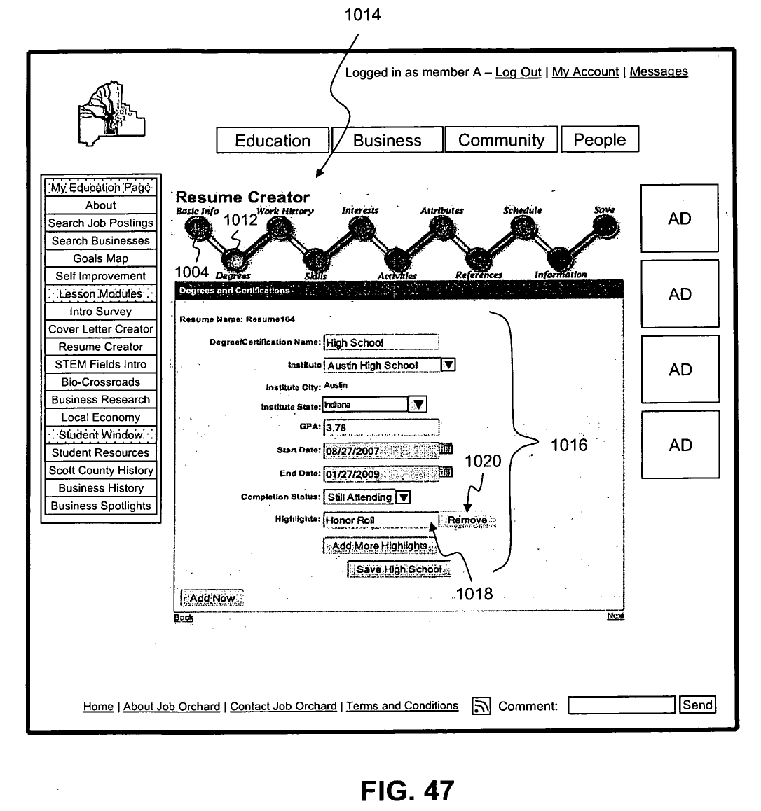

In FIG. 47, a degree portion 1012 is shown in screen 1014. Various fill in fields are provided to specify degree information. The viewer of screen 1014 completes the various fill in fields 1016 and selects one of the three selection inputs 1006, 1008, and 1010 at the bottom. With inputs 1018 and 1020 the viewer is able to specify highlights from their time completing their degree.

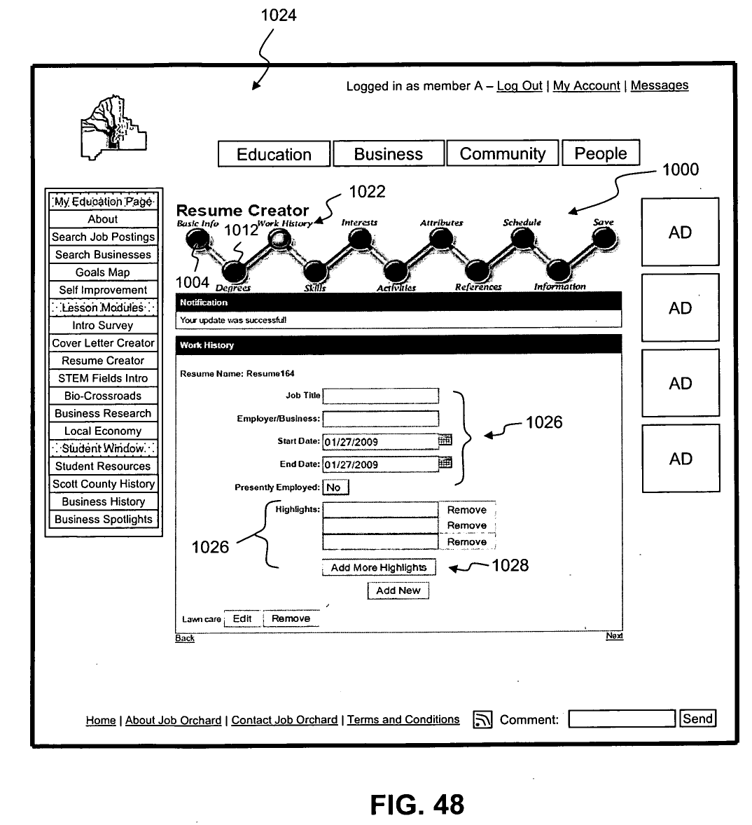

In FIG. 48, a work history portion 1022 is shown in screen 1024. Various inputs are provided to specify work history information . The viewer of screen 1024 completes the various inputs 1026 and selects one of the three selection inputs 1006, 1008, and 1010 at the bottom. With inputs 1026 and 1028 the viewer is able to specify highlights from their time completing their degree.

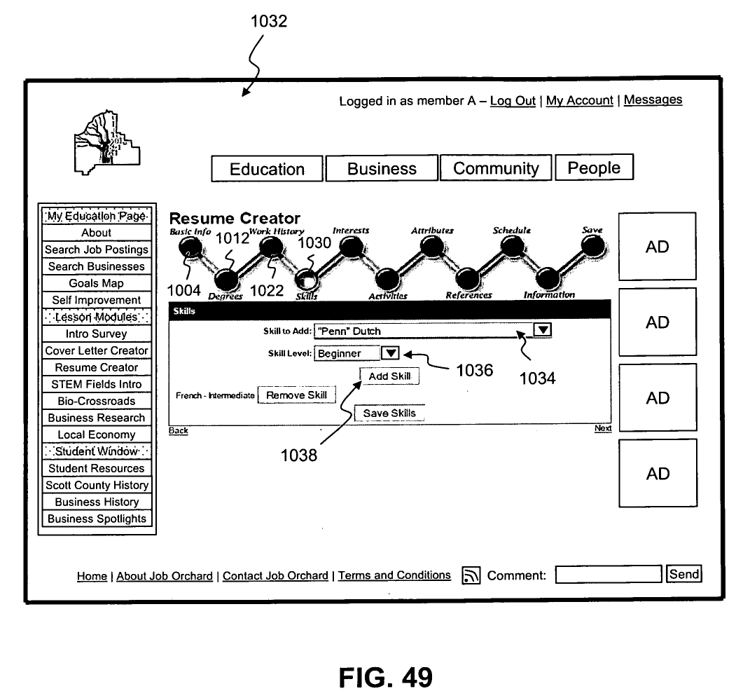

In FIG. 49, a skills portion 1030 is shown in screen 1032. The viewer of screen 1032 completes the various inputs 1034 and 1036 to specify a skill. The skill is added by selecting input 1038. Inputs 1034 and 1036 have a predefined set of possible selections to facilitate matching of the resume to job postings or job search inquiries. The user then selects one of the three selection inputs 1006, 1008, and 1010 at the bottom.

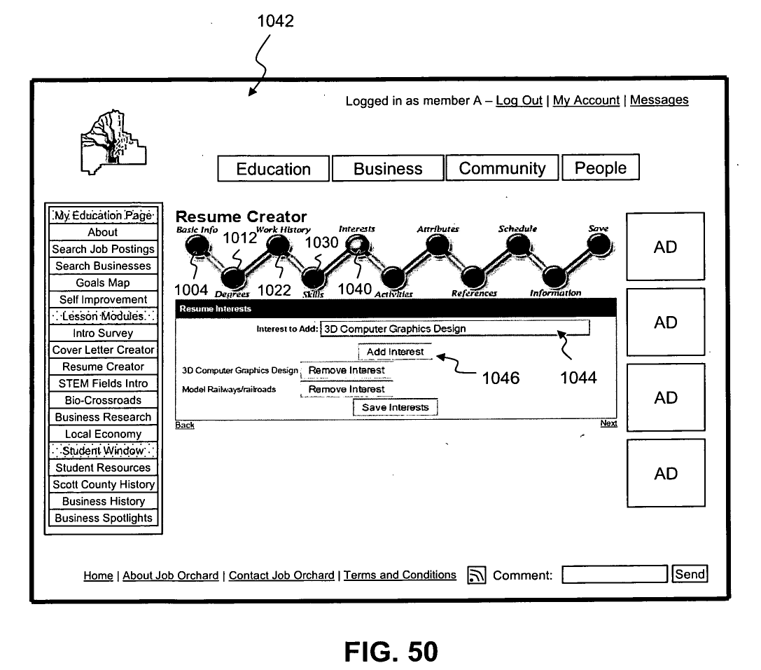

In FIG. 50, an interests portion 1040 is shown in screen 1042. An input 1044 has a predefined set of possible selections to facilitate matching of the resume to job postings or to job search inquiries. Input 1046 adds the interest to the resume. The user then selects one of the three selection inputs 1006, 1008, and 1010 at the bottom.

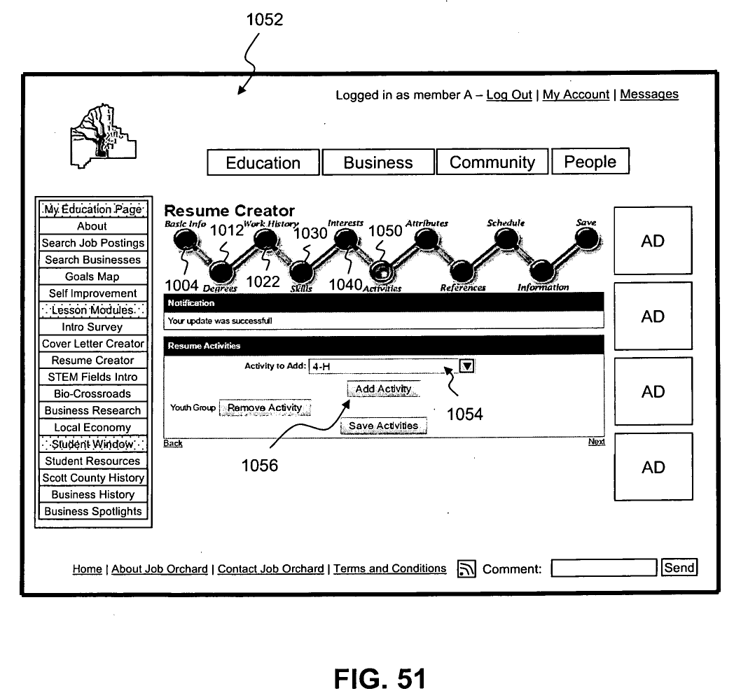

In FIG. 51, an activities portion 1050 is shown in screen 1052. An input 1054 has a predefined set of possible selections to facilitate matching of the resume to job postings or to job search inquiries. Input 1056 adds the activity to the resume. The user then selects one of the three selection inputs 1006, 1008, and 1010 at the bottom.

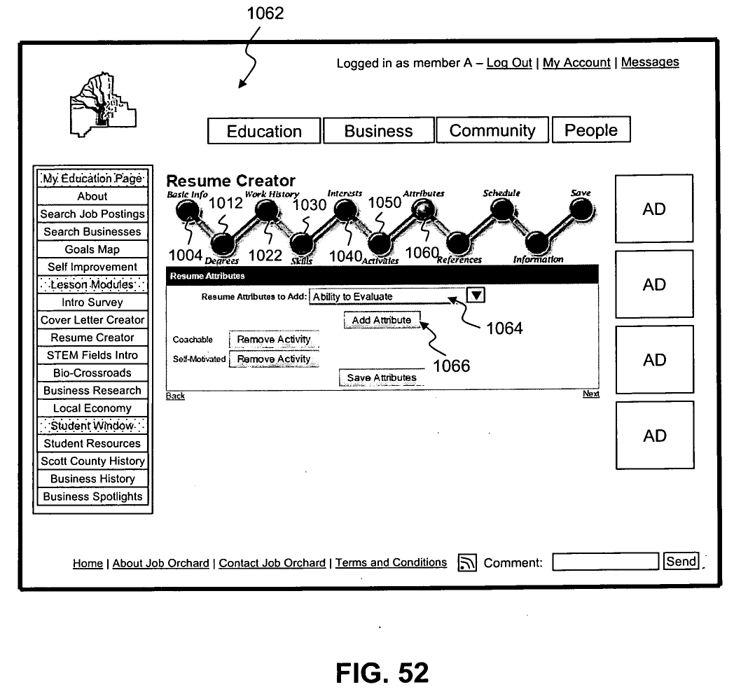

In FIG. 52, an attributes portion 1060 is shown in screen 1062. An input 1064 has a predefined set of possible selections to facilitate matching of the resume to job postings or to job search inquiries. Input 1066 adds the attribute to the resume. The user then selects one of the three selection inputs 1006, 1008, and 1010 at the bottom.

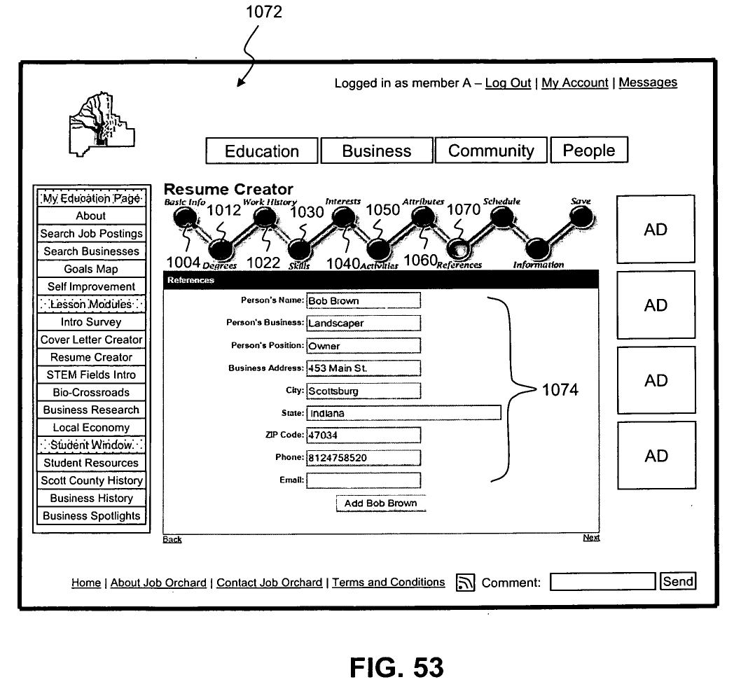

In FIG. 53, a reference portion 1070 is shown in screen 1072. Various inputs 1074 are provided to specify reference information. The viewer of screen 1072 completes the various inputs 1074. The user then selects one of the three selection inputs 1006, 1008, and 1010 at the bottom.

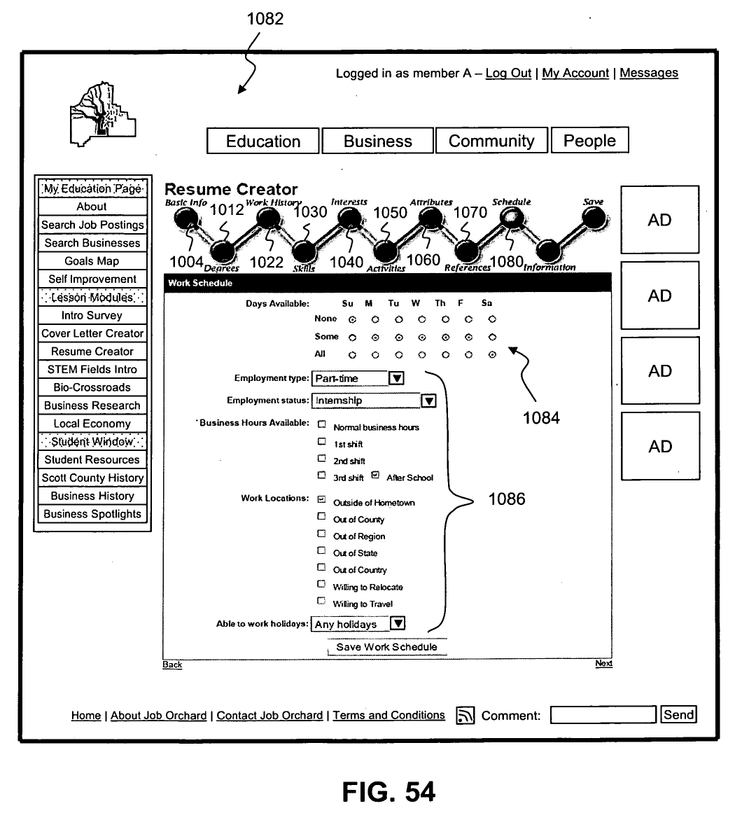

In FIG. 54, a work schedule portion 1080 is shown in screen 1082. Various inputs 1084 and 1086 are provided to specify work schedule information. The viewer of screen 1082 completes the various inputs 1084 and 1086. Inputs 1084 and 1086 have a predefined set of possible selections to facilitate matching of job postings to job search inquiries. Inputs 1084 and 1086 permit a viewer to specify a schedule for each day of the week, for hours of the day, and need to work holidays. The user then selects one of the three selection inputs 1006, 1008, and 1010 at the bottom.

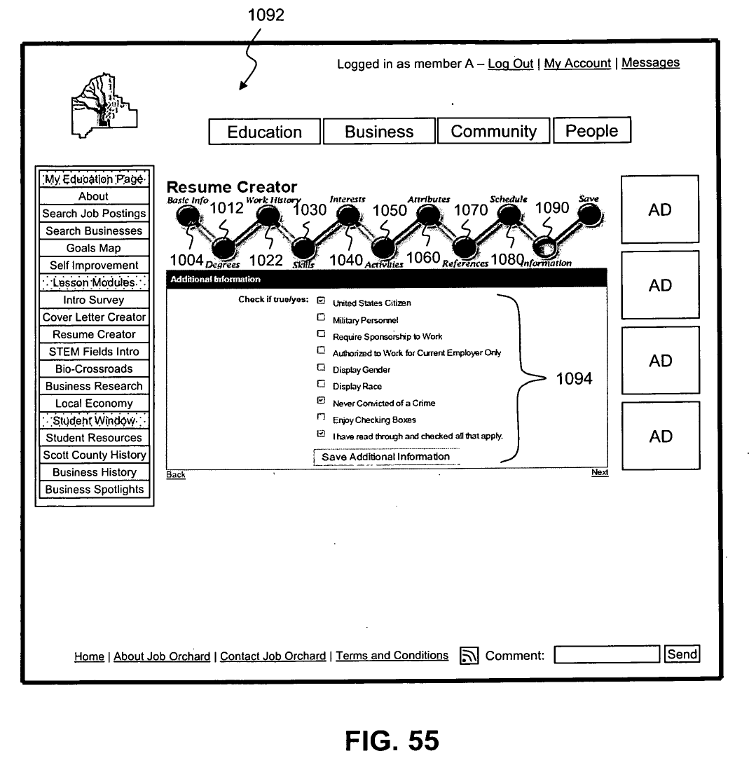

In FIG. 55 a miscellaneous information portion 1090 is shown in screen 1092. Inputs 1094 have a predefined set of possible selections to facilitate matching of the resume to job postings or to job search inquiries. The user then selects one of the three selection inputs 1006, 1008, and 1010 at the bottom.

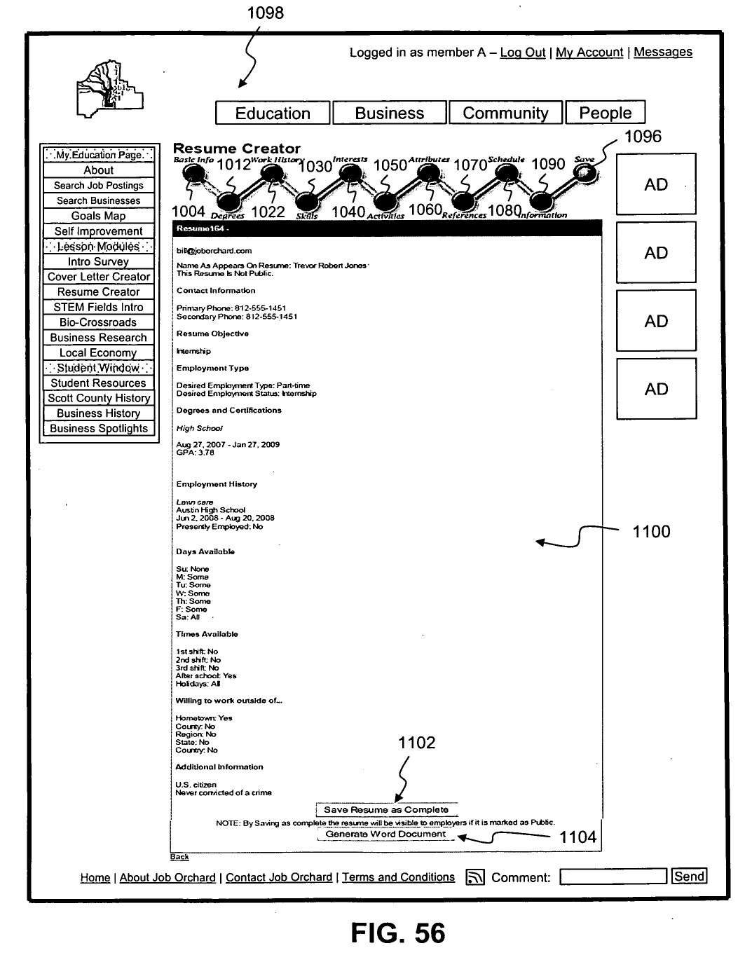

In FIG. 56, a save portion 1096 is shown in screen 1098. The information entered during the resume creation process is displayed as represented by reference number 100 for review. By selecting input 1102 the resume is saved to database 212. By selecting input 1104 a word processing document of a resume based on the entered information is provided.

Returning to FIG. 37, by selecting input 918 a STEM (science, technology, engineering, and mathematics) Field information page is displayed. An input (not shown) is also provided whereby a viewer may take a quiz on the content of the STEM Field information page which is provided by a STEM Fields application 1120 (see FIG. 5).

By selecting input 920 a Bio-Crossroads information page is displayed. By selecting input 922 a Business Research information page is displayed. By selecting input 924 a local economy information page is displayed. By selecting input 926 a student resources information page is displayed. By selecting input 928 a community history information page is displayed. By selecting input 930 a business history information page is displayed. By selecting input 932 a business spotlights information page is displayed along with links to the education link for the spotlighted business.

### People Portal

People portal 234 provides a social networking site which includes information stored in databases 212. People portal 234 provides access to multiple community people applications.

A first exemplary community people application is a messaging application 1140. The messaging application 1140 provides a member the ability to communicate with other members. Exemplary messaging applications include e-mail messaging and text messaging.

A second exemplary community people application is an events calendar application 1160. The events calendar application 1160 provides an interactive calendar for the community, portions of the community such as a group, and the individual member. The member is able to post both private calendar events, invitation only events which are reviewable by the intended recipient, and public events.

A third exemplary community people application is a web page application 1180. The web page application 1180 provides the member with the ability to post information about themselves, images, audio, and video on a web page viewable by the community. In one embodiment, web page application 1180 prevents the web page from being viewed by the whole community if the member's age is under 18. Unlike many other social networking pages, this will be tied to their real community, and family. As a result, the page will be closer to the user's real-life public self. Their grandmother, pastor, employer, mayor, children, wife, etc, will see this, so they'll be more professional. However, there will be layers. A user can determine who sees what information (e.g. the events they're attending, their blog, certain images, and other data.)

The People portal should be a place users want to visit several times a day, every day. In addition to being an exceptional way to interact with one's community, friends, and family, find jobs, etc. . . The People Portal includes entertainment applications. Games, chat, and Job Orchard-generated personas to interact with are just some of the tools planned for the People Portal. A point system has been discussed, allowing users to purchase features and tools with points gained from using the site. Instead of first creating an account to be greeted with a cookie-cutter page as in other social networks, they will start with a set pool of points with which to purchase their initial features. As they interact on the site, additional points will be collected. Users may be able to “gamble” these points in games, or cash them in with area businesses for discounts.

Users will be able to rate businesses online. Also, users will be able to add businesses and community entities to their homepage in a way similar to “friends.” If you have a favorite business or community entity, give it high ranking on your people portal webpage, and in this way send them business.

With Family becoming a more separated thing today (more family members working multiple jobs, students in activities, family members moving away), the People Portal will be a good place to keep active in family member's lives, even if you don't see them in person for days. Families of 3 or more may be allowed to make their Family Page, and determine who can see it. This will be full of details and updates about each family member.

Nearly all education portal tools are available in the people portal, but customized for each individual.

### Account Center

Referring to FIG. 58, an account center screen 1200 is shown in response to the selection of input 306. Shown in FIG. 57 is a Web presence interactive design tool 1204 which is displayed in response to a selection of input 1202. The account holder can alter the appearance of their web presence through various predefined selections with inputs 1206.

### Message Center

Referring to FIGS. 59 and 60, a message center screen 1250 is shown in response to the selection of input 308. In the illustrated embodiment, an e-mail application is shown. Shown in FIG. 59 is an inbox. Shown in FIG. 60 is a create new message.

### System Diagram

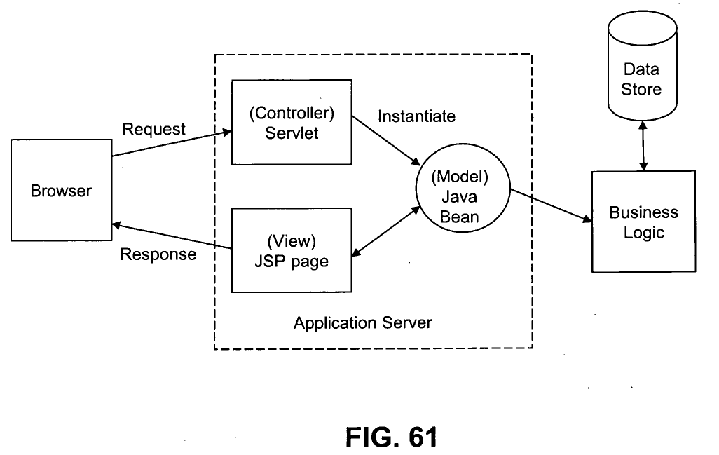

Referring to FIG. 61, in one embodiment, online community's technology stack is Windows Server Standard 2008 running IIS 7.0 for static content delivery and secure connection handling. Dynamic content, such as java servlets and java server pages (JSP) are handled via Tomcat 6.0 tied to IIS. The database is MySQL Server 5.0. The code is platform independent and could be quickly transferred to a Linux/Apache Web Server platform should the need arise. The user interface design incorporates strategies for making information accessible to everyone, keeping navigation consistent and intuitive across the site, presenting to users only what information they need and at the center of their visual attention, and finally keeping a clean and minimalist aesthetic. Community applications 202, in one embodiment, use the Java Model 2 design pattern, which is a Model-View-Controller architecture, separating business logic from user-interface considerations. This ensures that changes to either the user experience or the underlying business rules can be made easily without affecting the other. This also ensures easy dynamic tailoring of the user-interface to the user's community. In a Model 2 application, requests from the client browser are passed to the controller, which is a servlet. The controller decides which view (JSP) it will pass the request to. The view then invokes methods in a JavaBean (which may access a database) and returns the Response object to the Web container, which is then passed on to the client browser. In one embodiment, database 212 is designed to ensure data remains orderly and is not duplicated. Keeping the database normalized to at least the third normal form ensures data is not duplicated and prevents conflicting entries. Keeping database 212 highly standardized and well scrubbed requires further effort at the intersection of good code design and thoughtful human process design. As illustration: a poorly scrubbed database may have skill entries with “Certified Welder” and “Welding—Certified”, totally different entries to a computer. This data needs to be scrubbed: to point all references to a single entry and remove the duplicate. Database 212 is populated with drop-downs or other selection inputs which provide a predefined listing of responses. Still, members are allowed custom data, for example, by selecting “Other” from a drop down to enable a text field where they enter custom data. These member entries will be flagged and automatically routed for review by a database manager. Entries are accepted or corrected as needed and reasonable new entries are often “marked” as standard. This method grows the list of standard entries to accommodate the communities Job Orchard is deployed in and minimizes the need for human review. Entry acceptance/denial is a quick, interruptible, task that may be interspersed throughout the day, eliminating the need for dedicated “reviewing” staff.

Throughout this application information is sent between at least two computing devices. It is understood, that the sending computing device has a copy of the message stored in a memory accessible by the sending computing device and that the receiving computing device also has a copy of the message stored in a memory accessible by the receiving computing device. It is not required that a complete copy be stored before portions are sent, nor is it a requirement that a complete copy be received before the information therein may be used.

Although the invention has been described in detail with reference to certain preferred embodiments, variations and modifications exist within the spirit and scope of the invention as described and defined in the following claims.

1. A system for providing an online community having a plurality of spaced apart online community member computing devices which are connectable to a network, the system comprising:
a computing device being operatively connected to the plurality of online community member computing devices through the network;
a memory accessible by the computing device;
a database stored on the memory, the database including for each online community member information related to the online community member;
a business portal having a plurality of business community applications;
a community portal having a plurality of community applications;
a people portal having a plurality of people community applications; and
an education portal having a plurality of education community applications, wherein each of the business portal, the community portal, the people portal, and the education portal are accessible by an online community member over the network.

2. The system of claim 1, wherein the business community applications include a statistics application, a business administration application, a web presence application, a job posting application, a labor pool application, a succession application, an expansion application, an open calls application, a jobs and applicants application, a personnel scheduling application, an employee attributes application, and an entrepreneurship application.

3. The system of claim 1, wherein the community applications include a workforce application, a religious based directory application, a search function application, a web page application, an events calendar application, a community forum application, a directory of key features in the community application, a what is open application, a community sites application, and a scheduling application.

4. The system of claim 1, wherein the people community applications include a messaging application, an events calendar application, and a web page application.

5. The system of claim 1, wherein the education community applications include a cover letter creator application, a resume creator application, a goals application, a self-improvement application, a search job posting application, a search business application, and a student survey application.
